(19) United States
(12) Patent Application Publication
(10) Pub. No.: US 2019/0347361 A1
(43) Pub. Date: Nov. 14, 2019

(54) System and Method for Filtering Feeds within a Social Network Application

(71) Applicant: Sam R. Harkreader, Lake Jackson, TX (US)

(72) Inventor: Sam R. Harkreader, Lake Jackson, TX (US)

(21) Appl. No.: 15/977,737

(22) Filed: May 11, 2018

(51) Int. Cl. G06F 17/30; H04L 12/58; H04L 29/08

(52) U.S. Cl. CPC G06F 17/30867; G06Q 50/01; H04L 67/306; H04L 51/32

(57) ABSTRACT

A method for filtering feeds within a social network application is described. The method can include the step of providing a social network application available to a plurality of users, the social network application further comprising a page viewable by a subset of the plurality of users, the page comprising a feed. Further, the method can comprise the steps of receiving from the subset of users a plurality of posts to the feed, assigning one or more assigned post types from a plurality of post types to each post of the plurality of posts, filtering the posts based on a query by a user, displaying on the feed matching posts, the matching posts comprising the assigned post type that matches the query; and not displaying on the feed the non-matching posts. The non-matching posts not comprising the assigned post type that matches the query.

### BACKGROUND

This disclosure relates to a system and method for managing prayer requests within a social network application. This disclosure further relates to a system and method for facilitating a life event page within a social network application. This disclosure further relates to a system and method for facilitating church member networking within a social network application. Lastly, this disclosure relates to a system and method for filtering feeds within a social network application. For purposes of this disclosure, various embodiments are discussed and are an example of the above-mentioned systems and methods. However, such embodiments are solely exemplary, and not limiting.

Social networking has evolved rapidly over the last twenty years. Yet, while many secular options exist, no social network exists capable of meeting the needs of religious people. For example, a common activity of people of faith is prayer. People pray for themselves, and they pray for others. Further, it is common for the people to ask others to pray for them. Presently social network applications do not give users the ability to manage prayer requests. As such, it would be advantageous to have a system and method for managing prayer request within a social network application.

Further, life event pages on websites can be useful in making accessible obituaries and planning events such as weddings and birthdays. However, such sites are incapable of sharing and receiving important information from people outside of immediate contacts without making access public. As such, it would be advantageous to have a system and method for facilitating a life event page within a social network application.

Further, present church management software packages are expensive, standalone, and difficult to implement. Group pages within social network applications are typically free, tied to a large user base, and easy to implement. However, group pages within social network applications lack the tools necessary to effectively manage a church. As such, it would also be advantageous to have a system and method for facilitating church member networking within a social network application.

Lastly, feeds within existing social networks often contain posts of varying topics with no organization. However, a social network catering to religious people will often contain posts in predictable topics including, but not limited to, prayer requests, testimonials, devotionals, and praises. Furthermore, having the ability to organize posts by the poster or by favorited posts would be useful. As such, it would also be advantageous to have a system and method for filtering feeds within a social network application.

### SUMMARY

A method for managing prayer requests within a social network application is described herein. The method can comprise the steps of receiving by a social network application running on a server a first set of prayer requests from a first user of said social network application. The first set of prayer requests can be posted to a first feed of the social network application. The first feed can be associated with the first user. The method can also comprise the step of receiving by the social network application a second set of prayer requests from the first user of the social network application. The second set of prayer requests can be posted to a second feed of the social network application. The first user can be a member of a group having access to the second feed. The method can further comprise the steps of consolidating by the social network application the first set of prayer requests and the second set of prayer requests into a consolidated set of prayer requests and displaying by the social network application to the first user the consolidated set of prayers within a prayer list of the first user within the social network application.

In another embodiment, a system for managing prayer requests within a social network is disclosed herein. The system can comprise a memory, and a processor. The memory can comprise a social network application and a data store. The processor can, at the direction of the social network application, receive a first set of prayer requests from a first user of the social network application. The first set of prayer requests can be posted to a first feed of the social network application. The first feed can be associated with the first user. Moreover, according to the direction of the social network application, the processor can receive for the social network application a second set of prayer requests from the first user of the social network application. The second set of prayer requests can be posted to a second feed of the social network application. The first user can be a member of a group having access to the second feed. Additionally, the processor can consolidate for the social network application the first set of prayer requests and the second set of prayer requests into a consolidated set of prayer requests and can display by the social network application to the first user the consolidated set of prayers within a prayer list of the first user within the social network application.

In another embodiment, a method for facilitating a life event page within a social networking environment is disclosed herein. The method can comprise the step of providing a social network application available to a plurality of users. Each of the users can comprise a profile page on the social network application. A user of the users can comprise a set of friends. The set of friends is a first subset of the users. Further, the user can belong to a group within the social network application. The group can be a second subset of the users. The method can also comprise the steps of creating at the request of the user an event page and allowing at the request of the user the second subset of users to view the life event page, while preventing other users from viewing the life event. Life event page can be related to a life event of the user.

In another embodiment, a system for facilitating a life event page within a social network application is disclosed herein. The system can comprise a memory, and a processor. The memory can comprise a social network application and a data store. The processor can, at the direction of the social network application, provide the social network application to a plurality of users. Each of the users can comprise a profile page on the social network application. A user of the users can comprise a set of friends. The set of friends can be a first subset of the users. Further the user can belong to a group within the social network application. The group can be a second subset of the users. Moreover, according to the direction of the social network application, the processor can create at the request of the user an event page. The life event page can be related to a life event of the user and can allow at the request of the user the second subset of users to view the life event page, while preventing other users from viewing the life event page.

In another embodiment, a method for facilitating church member networking within a social network application is disclosed herein. The method can comprise the step of providing a social network application available to a plurality of users. Each of the users can comprise a profile page on the social network application. The method can also comprise the steps of creating a group page at a request of a user, and adding, individually, each of one or more other users as members to the group page.

In another embodiment, a system for facilitating church member networking within a social network application is disclosed herein. The system can comprise a memory and a processor. The memory can comprise a social network application and a data store. The processor can, according to instructions from the social network application, connect a plurality of users. Each of the users can comprise a profile page on the social network application. Moreover, according to instructions from the social network application, the processor can create a group page at a request of a user, and adds, individually, each of one or more other users as members to the group page.

In another embodiment, a method for filtering feeds within a social network application is disclosed herein. The method can comprise the step of providing a social network application available to a plurality of users. The social network application can further comprise a page viewable by a subset of the plurality of users. The page can comprise a feed. The method can also comprise the steps of receiving from the subset of users a plurality of posts to the feed and assigning one or more assigned post types from a plurality of post types to each post of the plurality of posts. The method can further comprise the steps of filtering the posts based on a query by a user and displaying on the feed matching posts. The matching posts can comprise the assigned post type that matches the query. Lastly, the method can comprise the step of not displaying on the feed the non-matching posts. Non-matching posts are posts that do not comprise the assigned post type that matches the query.

In another embodiment, a system for filtering feeds within a social network application is disclosed herein. The system can comprise a memory and a processor. The memory can comprise a social network application and a data store. The processor can, according to instructions from the social network application, connect a plurality of users. The social network application can further comprise a page viewable by a subset of the plurality of users. The page can comprise a feed. Moreover, according to instructions of the social network application the processor can receive from the subset of users a plurality of posts to the feed and can assign one or more assigned post types from a plurality of post types to each post of the plurality of posts. Furthermore, the processor can filter the posts based on a query by a user and can display on the feed matching posts. The matching posts can comprise the assigned post type that matches the query. Lastly, the processor does not display on the feed the non-matching posts.

Lastly, in another embodiment, a computer readable storage medium can have a computer readable program code embodied therein. The computer readable program code can be adapted to be executed to implement any of the above-mentioned methods.

### BRIEF DESCRIPTION OF THE DRAWINGS

FIG. 1 illustrates a social networking environment comprising a computer, and one or more server.

FIG. 2 illustrates a schematic diagram of server according to an embodiment of the present disclosure.

FIG. 3 illustrates a server data store comprising a plurality of users, a plurality of pages, and a plurality of posts data.

FIG. 4 illustrates an embodiment of a group page.

FIG. 5 illustrates an embodiment of a church page.

FIG. 6 illustrates an embodiment of a prayer list page.

FIG. 7 illustrates an embodiment of an event page.

FIG. 8 illustrates an embodiment of a wedding page.

FIG. 9 illustrates an embodiment of an obituary page.

FIG. 10 illustrates an embodiment of a post data.

FIG. 11 illustrates main page of social network application.

FIG. 12 illustrates a profile page screen.

FIG. 13 illustrates an embodiment of an unapproved church page screen.

FIG. 14 illustrates a site administrator screen.

FIG. 15A illustrates an embodiment of an approved church page screen.

FIG. 15B illustrates a settings menu screen.

FIG. 15C illustrates an email invitation screen.

FIG. 16 illustrates a prayer list screen.

FIG. 17 illustrates a public group page screen.

FIG. 18 illustrates a public event embodiment of life event screen.

FIG. 19 illustrates a wedding page screen.

FIG. 20 illustrates an obituary screen.

FIG. 21 illustrates an exemplary method for managing prayer requests.

FIG. 22 illustrates an exemplary method for facilitating a life event page.

FIG. 23 illustrates an exemplary method for facilitating church member networking.

FIG. 24 illustrates an exemplary method for filtering feeds.

### DETAILED DESCRIPTION

Described herein is a system and method for managing prayer requests within a social network application. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments but are to be accorded their widest scope consistent with the principles and features disclosed herein.

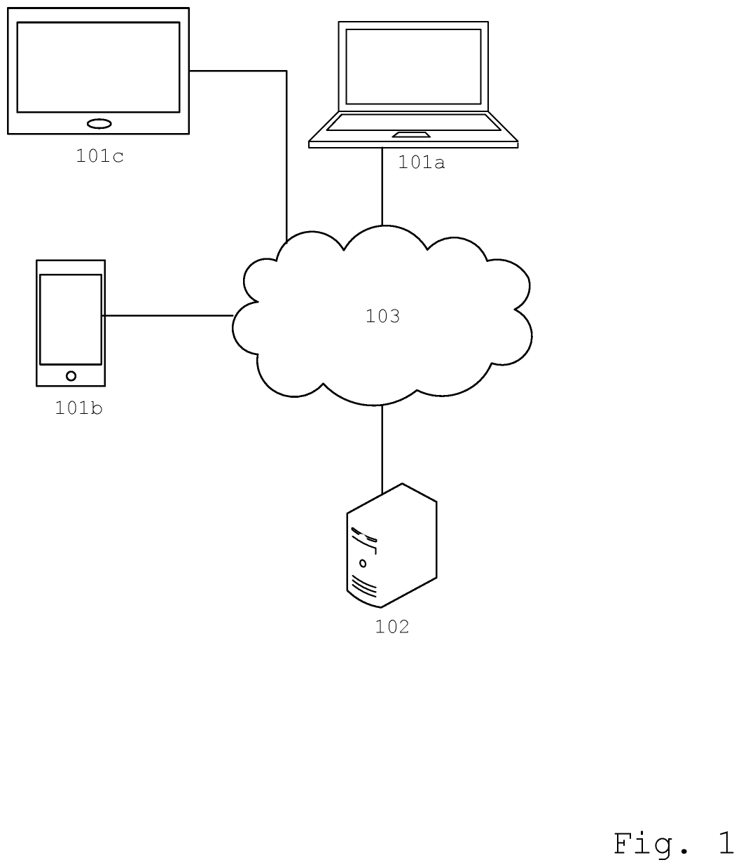

FIG. 1 illustrates a social networking environment 100 comprising a computer 101, and one or more server 102. Computer 101 can be a desktop computer, laptop, tablet, or smartphone. Server 102 represents at least one, but can be many servers, each connected to network 103 capable of performing computational task, and storing data information. Network 103 can be a local area network (LAN), a wide area network (WAN), a piconet, or a combination of LANs, WANs, or piconets. One illustrative LAN is a network within a single business. One illustrative WAN is the Internet. In the preferred embodiment, network 103 will comprise the Internet.

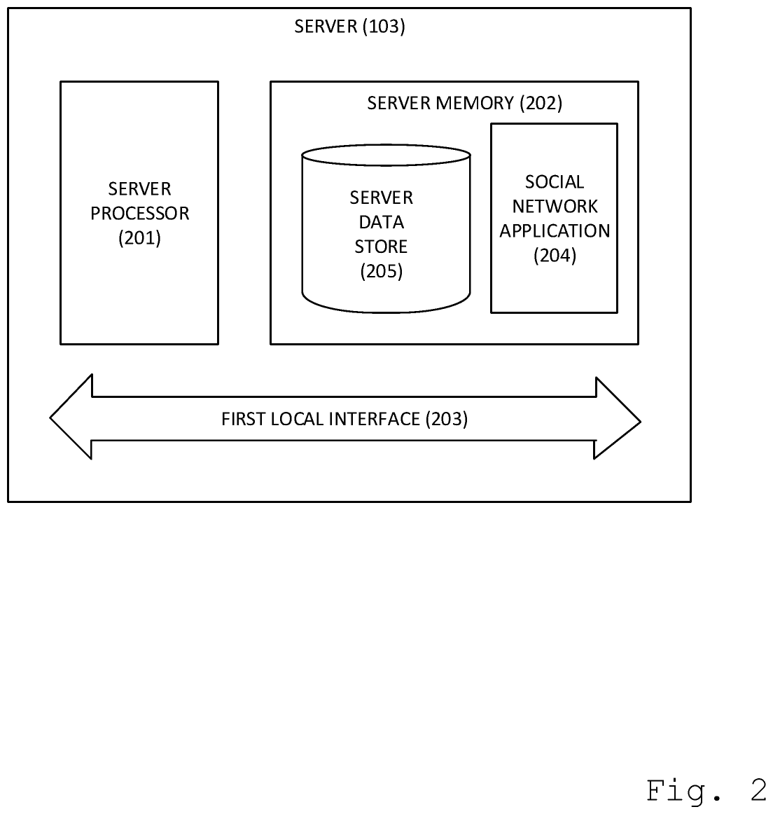

FIG. 2 illustrates a schematic diagram of server 102 according to an embodiment of the present disclosure. Server 102 can comprise a server processor 201, and a server memory 202 and a local interface 203. Local interface 203 can be a program that controls a display for the user, which can allow user to view and/or interact with server 102. Server processor 201 can be a processing unit that performs a set of instructions stored within server memory 202. Server memory 202 can comprise a social network application 204, and a data store 205. In one embodiment, social network application 204 can be a social networking service that can be used by religious individuals who share the same connections, interests, backgrounds, and/or activities. Social network application 204 can comprise business logic for server 102. In this embodiment, social network application 204 can contain HTML (Hyper Text Markup Language), PHP, scripts, and/or applications. Data store 205 can be collections of data accessible through social network application 204. Further, social network application 204 can perform functions such as adding, transferring and retrieving information on data store 205 using local interface 203.

Server 102 includes at least one processor circuit, for example, having server processor 201 and server memory 202, both of which are coupled to local interface 203. To this end, server 102 can comprise, for example, at least one server, computer or like device. Local interface 203 can comprise, for example, a data bus with an accompanying address/control bus or other bus structure as can be appreciated.

In particular, stored in the server memory 202 and executable by server processor 201 are social network application 204, and potentially other applications. Also stored in server memory 202 can be server data store 205 and other data. In addition, an operating system can be stored in server memory 202 and executable by server processor 201.

It is understood that there can be other applications that are stored in server memory 202 and are executable by server processor 201 as can be appreciated. Where any component discussed herein is implemented in the form of software, any one of a number of programming languages can be employed such as, for example, C, C++, C#, Objective C, Java, Java Script, Perl, PHP, Visual Basic, Python, Ruby, Delphi, Flash, or other programming languages.

A number of software components can be stored in server memory 202 and can be executable by server processor 201. In this respect, the term “executable” means a program file that is in a form that can ultimately be run by server processor 201. Examples of executable programs can be, for example, a compiled program that can be translated into machine code in a format that can be loaded into a random access portion of server memory 202 and run by server processor 201, source code that can be expressed in proper format such as object code that is capable of being loaded into a random access portion of server memory 202 and executed by server processor 201, or source code that can be interpreted by another executable program to generate instructions in a random access portion of provider memory 202 to be executed by server processor 201, etc. An executable program can be stored in any portion or component of server memory 202 including, for example, random access memory (RAM), read-only memory (ROM), hard drive, solid-state drive, USB flash drive, memory card, optical disc such as compact disc (CD) or digital versatile disc (DVD), magnetic tape, network attached/addressable storage or other memory components.

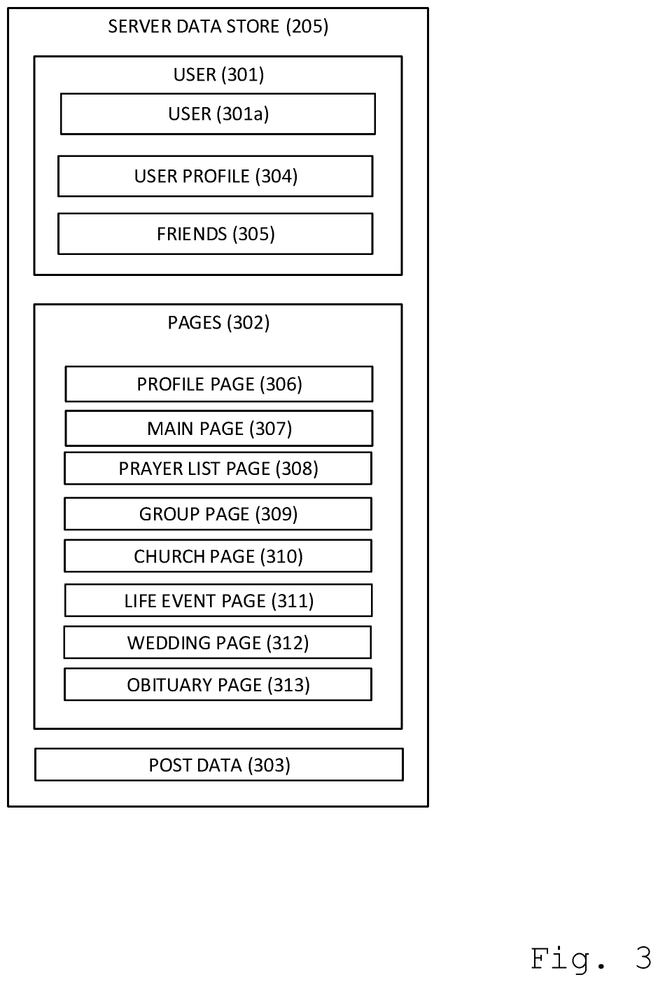

FIG. 3 illustrates server data store 205 comprising a plurality of user 301, a plurality of pages 302, and a plurality of posts data 303. In an example scenario, an individual who can be interested to share thoughts, or who wanted to be a part of religious group can register on social network application 204. An individual registering on social network application 204 can also be related to storing a first user 301a on users 301 of server data store 205. As such, users 301 can be individuals belonging to a particular religious group and religious community that can be within social network application 204. Each user 301 can have a user profile 304 and one or more friends 305. User profile 304 can comprise of identification information that each user 301 entered during registration on social network application 204. In one embodiment, user profile 304 can include but is not limited to name, email address, phone, login credentials, gender, marital status, and address. Further after a successful registration, social network application 204 can store pages 302 associated with first user 301a. Pages 302 that can be associated with registration of user 301 can comprise a profile page 306, a main page 307, and a prayer list page 308. As such, each user 301 can have their own profile page 306, main page 307, and prayer list page 308. As an example, first user 301a who can be currently logged in on social network application 204 can have access to his own profile page 306, main page 307, and prayer list page 308. Profile page 306 can comprise personal information that first user 301a entered during registration on social network application 204. Profile page 306 can be the page that shows up when other users 301 search for a specific individual on social network application 204. Main page 307 can be a page that can only be visible to the currently logged in user. Main page 307 can comprise of contents shared by first user 301a, friends 305 of first user 301a. Prayer list page 308 can be a page that allows first user 301a to manage prayer requests that first user 301a created and friends 305 of first user 301a have created.

Further in one embodiment, first user 301a can begin connecting with other users 301, by searching, and adding other users 301 on social network application 204. Once other users 301 have been added by first user 301a, social network application 204 can store and associate added users to friends 305 of first user 301a. In one embodiment, friends 305 can be a set of friends, comprising of individuals that first user 301a can have a direct connection with such as family, friends, relatives, etc.

Further in one embodiment, other pages 302 on server data store 205 that can be associated to first user 301a can include but are not limited to one or more group pages 309, one or more church pages 310, one or more life event pages 311, one or more wedding pages 312, and one or more obituary pages 313. Group page 309 can be related to a specific group, such as a church group, a worship band group, or a Christian singer group created on social network application 204. Each church page 310 can be related to a specific church such as First Baptist church stored on social network application 204. In one embodiment, each life event page 311 can be a public event such as conferences, concerts, prayer meetings, festivals, outreach, etc., which can be attended by users 301. In another embodiment, each life event page 311 can be a private event related to first user 301a such as a wedding, or an obituary. Each wedding page 312 can be a page related to wedding event of each users 301. Each obituary page 313 can be related to obituary events of each user 301. In some embodiments, first user 301a can create, participate, and/or join specific pages 302 that can be stored within social network application 204, which can be further discussed below. Post data 303 can comprise of data information shared by each user 301 on pages 302 of social network application 204.

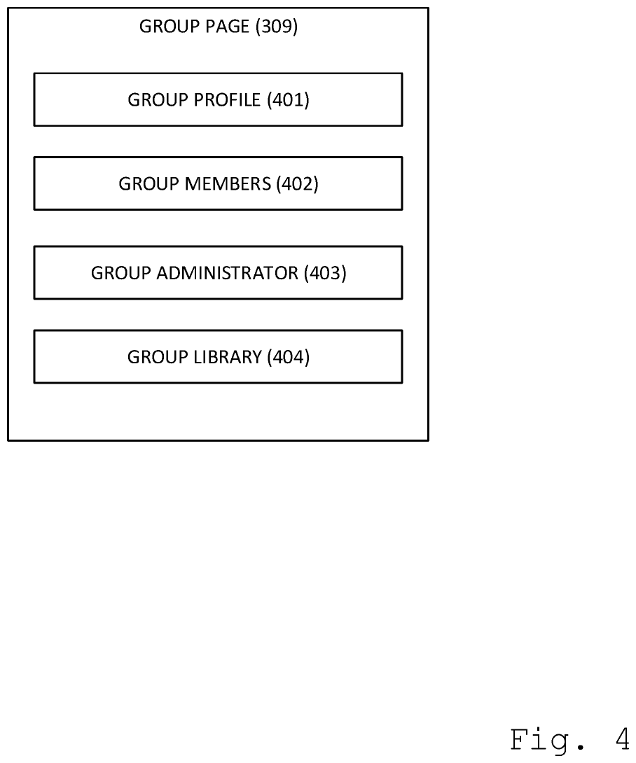

FIG. 4 illustrates an embodiment of a group page 309. Group page 309 can comprise a group profile 401, a plurality of group members 402, one or more group administrators 403, and a group library 404. In one embodiment, first user 301a can view existing group pages 301 on social network application 204. In one embodiment, group pages 301 that can be set as private cannot be searchable by users 301. In such embodiment, a specific group of users having permission or an access code can search and join the specific group page 309. In one embodiment, users 301 on social network application 204 can search group pages 301 set to public. In one embodiment, users 301 viewing a specific group page 309 can be permitted to view group profile 401 and view group members 402 of the page. Group profile 401 can be group information, such as group name, and group description that was entered during the creation of a specific group page 309. Group members 402 can be a set of users 301 that were accepted to join group page 309. Further in another embodiment, users 301 that can be a member of group page 309 can be allowed to view group profile 401, group members 402, and group library 403 of group page 309. Additionally, group members 402 can share and publish content, such as post data 303 on group page 309. Group administrators 403 can comprise of one or more group members 402 that has the permission to manage group page 309 and manage group members 402. In one embodiment, the specific user who created group page 309 can be assigned as a group administrator by default. As such, group administrator 403 can be allowed to update contents and information of group page 309. Moreover, group administrator 403 can block group members 402 from group page 309. In one embodiment, group members 402 and group administrators 403 can invite other users 301 to join group page 309. In another embodiment, only group administrators 403 can send group invitations to users 301 to join group page 309. In one embodiment, first user 301a, which can be group administrator 403, can send a group invitation to first user's friends 305. In another embodiment, first user 301a, which can also be group member 402 of another group page 309, can send a group invitation to first user's co-group members 402. In these embodiments, friends 305 can be a first subset of first user 301a, while co-group member 402 can be a second subset of first user 301a. Group library 404 can comprise of documents and files uploaded and shared by group members 402 within group page 309. Further in one embodiment, group page 301 can be a church page. In such embodiment, church information can be supplied during the creation of group page 301. In one embodiment, a church page created through this method may not have some functions, such as the access code function, which, depending on embodiment, may only be available when creating church page 310.

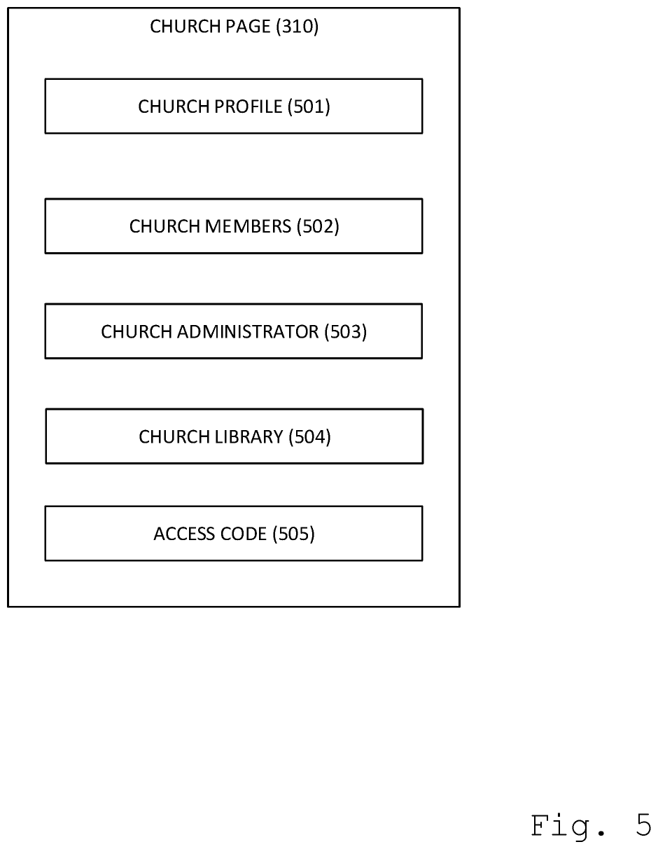

FIG. 5 illustrates an embodiment of a church page 310. In one embodiment, church page 310 can comprise a church profile 501, a plurality of church members 502, one or more church administrators 503, a church library 504, and an access code 505. In one embodiment, group page 309 can be similar to church page 310. As such church page 310 can allow same permissions to each member and can allow same functions similar with group page 309, such as inviting, and/or blocking of group members. Further in one embodiment, first user 301a can view existing church pages 310 on social network application 204. In one embodiment, church pages 310 that can be set as private cannot be searchable by users 301. In such embodiment, only specific group of users having permission or an access code can search and join the specific church page 310. In one embodiment, users 301 on social network application 204 can search church pages 310 set to public. In one embodiment, users 301 viewing a specific church page 310 can be permitted to view church profile 501 and view church members 502 of the page.

Church profile 501 can comprise church information such as name of the church, pastor's name, denomination, address of church, and church contact information that was entered during the creation of a specific church page 310. Church members 502 can be associated with other users 301 that were accepted to join church page 310. Church members 502 can be allowed to view church profile 501, church members 502, and church library 503 of church page 310. Additionally, church members 502 can share and publish content, such as post data 303 on church page 310. Church administrators 503 can comprise of one or more church members 502 that has permission to manage church page 310 and manage church members 502. In one embodiment, the specific user who created church page 310 can be assigned as church administrator 503. Church administrator 503 can update contents and information of church page 310. Moreover, church administrator 503 can block specific church members 502 from church page 310. In one embodiment, church members 502 and church administrators 503 can invite other users 301 to join church page 310. In another embodiment, only church administrators 503 can send church invitations to users 301. As an exemplary embodiment, first user 301a, which can be church administrator 503, can send a group invitation to first user's friends 305. In another embodiment, first user 301a, which can also be group member 402 of other group page 309, can send a church invitation to first user's co-group member 402. Church library 504 can comprise of documents, and files uploaded and shared by church members 502 on church page 310. Further in one embodiment, church page 310 can be a closed group. As such, church page 310 can require access code 505 from members joining the page. Access code 505 can be an auto-generated code that can be assigned to a specific church page 310. As such, access code 505 can be a unique identification code assigned to each church page 310. In one embodiment, only church administrators 503 can view access code 505. Church administrators 503 can give access code 505 to users 301 that can be allowed to join church page 310. As such, users 301 with access code 505 can join the specific church page by providing access code 505 on church page 310.

Further in one embodiment, creating a new church page 310 can require approval from a site administrator of social network application 204. In such embodiment, church pages 304 that can be awaiting approval from the site administrator can be unable to add or invite new members. Once the newly created church page 310 is approved, church administrator 503 that created church page 310 can start inviting users to be a church member of the newly created church page.

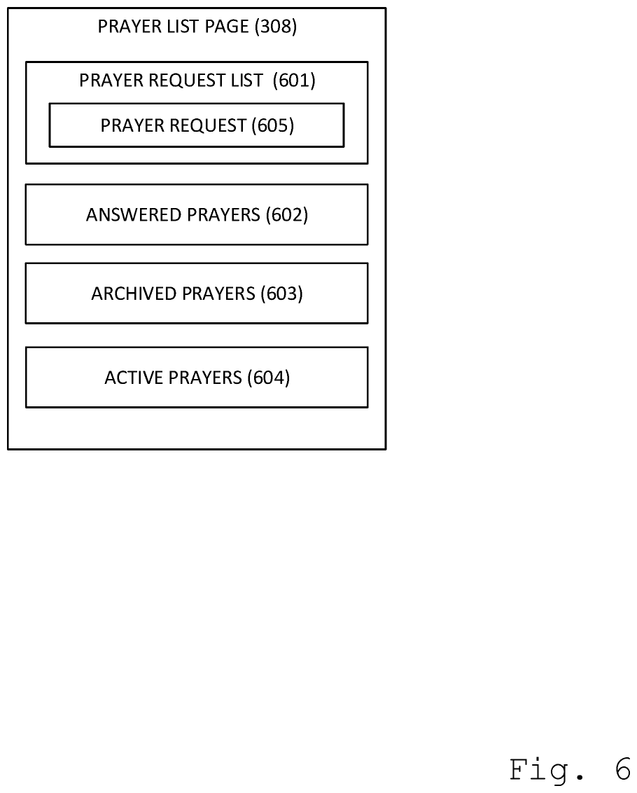

FIG. 6 illustrates an embodiment of a prayer list page 308. In one embodiment, prayer list page 308 can comprise a prayer request list 601, one or more answered prayers 602, one or more archived prayers 603, and one or more active prayers 604. In one embodiment, first user 301, by having an access on profile page 306, can create post data 303 on social network application 204. In one embodiment, post data 303 created by first user 301 can be one or more prayer requests 605. In one embodiment, prayer request 605 can be a type of post that can be shared on first user's profile page 306. In another embodiment, prayer request 605 can be shared on first user's main page 307. In such embodiments, post data 303 such as prayer requests 605 made on profile page 306 and main page 307 can each be related to a first feed displayed on social network application 204. Further in another embodiment, prayer request 605 can be shared on other pages where first user 301a belongs. In one embodiment, first user 301 belonging to group page 309 can share prayer request 605 on group page 309. In another embodiment, first user 301 belonging to church page 310 can share prayer request 605 on church page 310. In some embodiments, first user belonging to life event page 311 can share prayer request 605 on life event page 311. In these embodiments, post data 303 such as prayer requests 605 made on group page 309, church page 310, and life event page 311 can each be related to a second feed displayed on social network application 204.

Prayer request list 601 can comprise a consolidated set of prayer requests. In one embodiment, prayer request list 601 can comprise one or more prayer requests 605 that can be created by first user 301a. In another embodiment, prayer request list 601 can comprise of prayer requests 605 that can be bookmarked by first user 301a. Posts, such as prayer requests 605, which can be stored on post data 303 can be viewed and bookmarked by first user 301a social network application 204. In one embodiment, a specific prayer request 605 made by friends 305 of first user 301a can be viewed and bookmarked by first user 301a through main page 307. In another embodiment, a specific prayer request 605 made by first user's co-group member 402 on group page 309 can be viewed by first user 301a through main page 307 or group page 309. First user 301a can then choose to bookmark the specific prayer request 605 made by co-group member 402. Once bookmarked, social network application 204 can then receive and store bookmarked prayer request 605 on prayer request list 601. Further in another embodiment, another prayer request 605 made by first user's co-church member 502 on church page 310 can be viewed by first user 301a through main page 307 or group page 309 of social network application 204. First user 301a can then choose to bookmark the other prayer request 605 made by co-group member 402. Once bookmarked, social network application 204 can then receive and store bookmarked prayer request 605 on prayer request list 601.

Answered prayers 602 can be prayer requests 605 that can be finally granted or answered by the Lord. Answered prayers 602 can comprise of prayer requests 605, which can be marked as answered prayer by first user 301a. In one embodiment, answered prayers 602 can comprise prayer requests 605 that can be created by first user 301a. In another embodiment, answered prayers 602 can comprise of prayer requests 605 that can be bookmarked by first user 301a. In one embodiment, only an author or the creator of prayer request 605 can be allowed to mark prayer request 605 as answered. As an example, once prayer request 605 made by first user 301a has been answered by the Lord, first user 301a can mark prayer request 605 as answered. In one embodiment, first user 301a can add a comment, or thoughts on the prayer request that has been marked as answered. Further in another embodiment wherein first user 301a bookmarked a specific prayer request 605 made by a specific co-church member 502, first user 301a can choose to be notified once the specific prayer request 605 has been answered by the Lord. As such, once the specific co-church member 502 marks his specific prayer request 605 as answered, first user 301a can receive a notification that the specific bookmarked prayer request 605 has been answered. In one embodiment, prayer requests 605 that have been marked as answered can be removed from prayer request list 601 and be moved to archived prayers 603.

In one embodiment, archived prayers 603 can be prayer requests 605 that have been answered. In such embodiment, prayer requests 605 that have been answered can be automatically moved by social network application 204 to archived prayers 603. In another embodiment, archived prayers 603 can be prayer requests 605 that can be manually marked as archived by first user 301a. In such embodiment, first user 301a can choose to be notified first by social network application 204 before prayer requests 605 that have just been answered can be moved to archived prayers 603. In one embodiment, active prayers 604 can be prayer request 605 that have not been marked as answered. In another embodiment, active prayers 604 can be prayer request 605 that have not been archived by first user 301a.

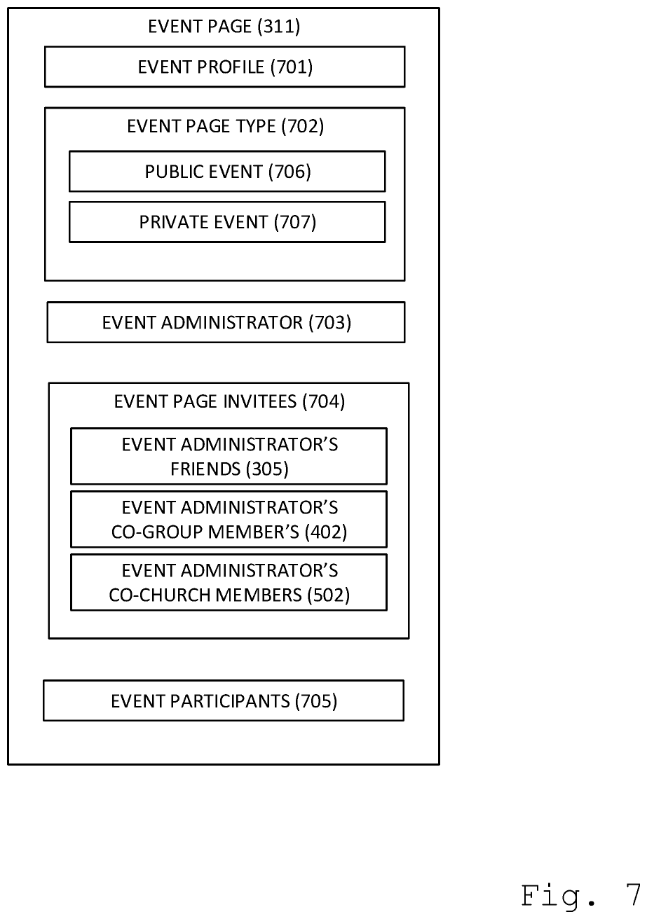

FIG. 7 illustrates an embodiment of a life event page 311. In one embodiment, life event page 311 can comprise event information 701, an event page type 702, an event administrator 703, event page invitees 704, and event participants 705. In one embodiment, life event page 311 can be related to a specific user's life events such as weddings, obituary, concerts, outreach programs, etc. Event information 701 can relate to the event information, such as name of the event, event description, event location, and event date, which a specific user entered during the creation of the specific event page 701. Event page type 702 can relate to visibility of life event page 311 to users 301. In one embodiment event page type 702 can be set during the creation of life event page 311. As such, life event page 311 can either be set to a public event 706 or a private event 707. In one embodiment, life event page 311 set as public event 706 can be visible and searchable to all registered users 301 of social network application 204. In another embodiment, life event page 311 set as private event 707 can only be visible to selected group of users. In such embodiment, event administrator 703 can be the only user permitted to invite event participants 704. In one embodiment, event administrator 703 can be a specific user 301 that created life event page 311. Further in an embodiment wherein life event page 311 can be private event 707, event page invitees 704 can comprise event administrator's friends 305, event administrator's co-group members 402, and event administrator's co-church members 503. In one embodiment, first user 301a, which can be event administrator 703, can send an event invitation to first user's friends 305. In another embodiment, first user 301a, which can also be group member 402 of group page 309, can send event invitation to first user's co-group members 402. Further in another embodiment, first user 301a, which can also be church member 502 of church page 310, can send event invitation to first user's co-church members 502. In these embodiments, friends 305 can be first subset of first user 301a, while co-group members 402, and co-church members 502 can be second subset of first user 301a. In one embodiment, event invitees 704 and event participants 705 can be allowed to respond on the event invitation by responding on an RSVP response option of life event page 311. RSVP response option can comprise a response such as “participate”, “interested”, or “decline”. As such, users 301 that can view life event page 311 can select a desired RSVP response from the RSVP response option. Users 301 who responded, “decline” can be users 301 who would not want to participate in the event. Users 301 who responded, “interested” can be users 301 who would want to participate in the event but have not decided to participate yet. And, users 301 who responded, “participate” can be users 301 who would want to participate in the event and have decided to participate. As such, event participants 705 can comprise of users 301 that can participate in the event shown on life event page 311.

Further in an embodiment wherein the event page can be public event 706, non-invited users can only search and preview specific life event page 311. In another embodiment where life event page 311 is a public event 706, event participants 705 can be allowed to view life event page 311 contents such as event details, and event participants 705, but cannot be permitted to invite other users 301 to participate on life event page 311. Further in an embodiment wherein life event page 311 can be private event 707, event participants 705 can be allowed to view life event page 311 contents such as event details, and event participants 705, but cannot be permitted to invite other users 301 to participate on life event page 311.

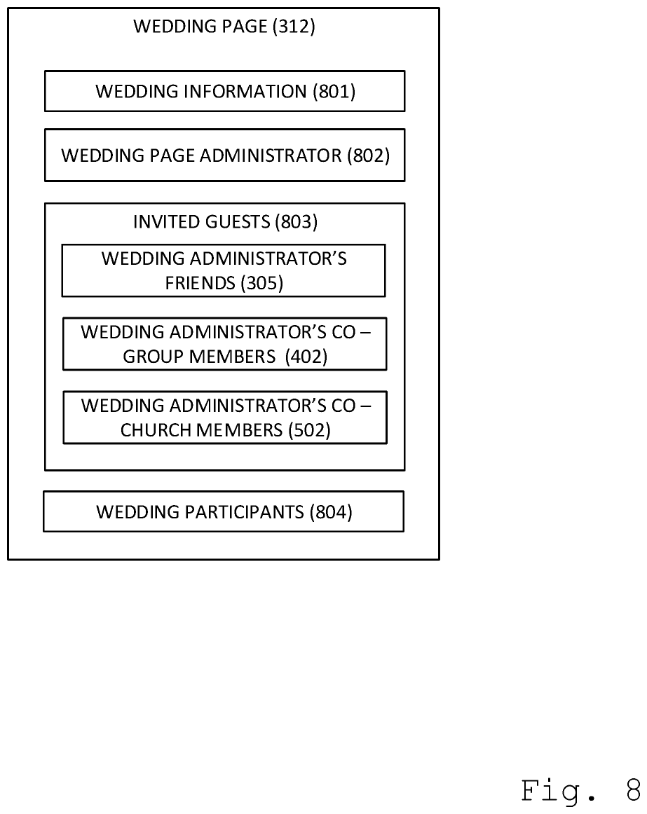

FIG. 8 illustrates an embodiment of a wedding page 312. In one embodiment, wedding page 312 can comprise wedding information 801, a wedding page administrator 802, one or more invited guests 803, and one or more wedding participants 804. In one embodiment, wedding page 312 can be related to a user's own life event such as the user's wedding. In such embodiment, wedding page 312 can be private event 707. As an exemplary embodiment, first user 301a whose about to get married can create wedding page 312 on social network application 204 to inform and/or invite first user's chosen subset of users. As such, creating wedding page 312 on social network application 204 can be related to storing wedding page 312 on data store 205. Through the process of creating wedding page 312, first user 301a can supply details on the wedding such as the name of the bride and groom, wedding location map, wedding photos, name of parents of the bride and groom, links to external gift registries, and links to external wedding album. Details of the wedding can be related to wedding information 801. Once wedding page 312 has been created, first user 301a who created wedding page 312 can be assigned as wedding administrator 802. Wedding administrator 802 can be the only user allowed to update wedding information 801 and invite wedding participants 804 on wedding page 312. As such, invited guests 803 can comprise of wedding administrator's friends 305, wedding administrator's co- group members 402, and wedding administrator's co-church members 502. In one embodiment, first user 301a, which can be wedding administrator 802, can send an event invitation to first user's friends 305. In another embodiment, first user 301a, which can also be a group member of group page 309, can send event invitation to first user's co-group members 402. Further in another embodiment, first user 301a, which can also be church member 502 of church page 310, can send event invitation to first user's co-church members 502. In one embodiment, invited guests 803 and wedding participants 804 can be allowed to respond on the wedding invitation by responding on an RSVP response option, which can be available on wedding page 312. In one embodiment, RSVP response option can comprise a response such as “participate”, “interested”, or “decline”. As such, users 301 that can view wedding page 312 can select a desired RSVP response from the RSVP response option. Users 301 who responded, “decline” can be users 301 who would not want to participate in the wedding. Users 301 who responded “interested” can be users 301 who would want to participate in the wedding but have not decided to participate yet. And, users 301 who responded, “participate” can be users 301 who would want to attend the wedding and have decided to participate. As such, wedding participants 804 can comprise of users 301 that can participate in the wedding shown on wedding page 312.

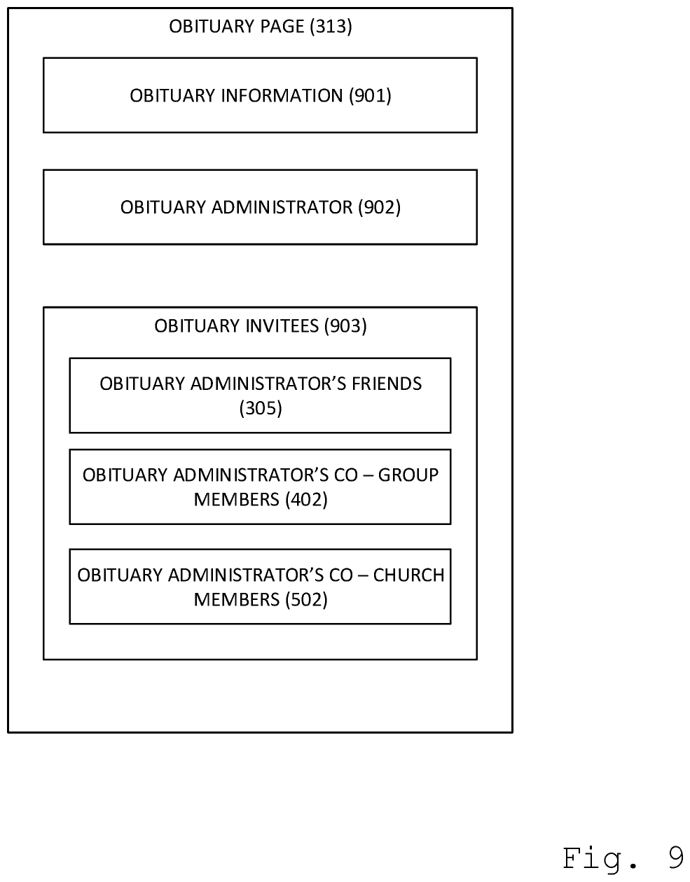

FIG. 9 illustrates an embodiment of an obituary page 313. In one embodiment, obituary page 313 can comprise obituary information 901, obituary administrator 902, and obituary invitees 903. In one embodiment, obituary page 313 can be a page created by first user 301a who can be experiencing loss of loved ones, such as a friend, a relative, etc. First user 301a can create obituary page 313 to share obituary information 901 with first user's chosen subset of users. As such, obituary page 313 can be a private event 707. Obituary information 901 can relate to the obituary details such as the name of the decedent, obituary text, funeral service details, image of the decedent, and a map to the funeral services location, which first user 301a can supply during the creation of the specific obituary page 313. In one embodiment, first user 301a who created obituary page 301 can be assigned as obituary administrator 902. Obituary administrator 902 can update obituary information 901 on obituary page 313. Further in one embodiment, obituary administrator 902 can allow subset of users to view obituary page 313. Obituary page invitees 903 can comprise of users allowed to view obituary page 313. In one embodiment, obituary page invitees 903 can comprise obituary administrator's friends 305, obituary administrator's co-group members 402, and obituary administrator's co-church members 502. In such embodiment, users 301 that can be within the subset of users of obituary page 313 can be allowed to view obituary information 901 on obituary page 313.

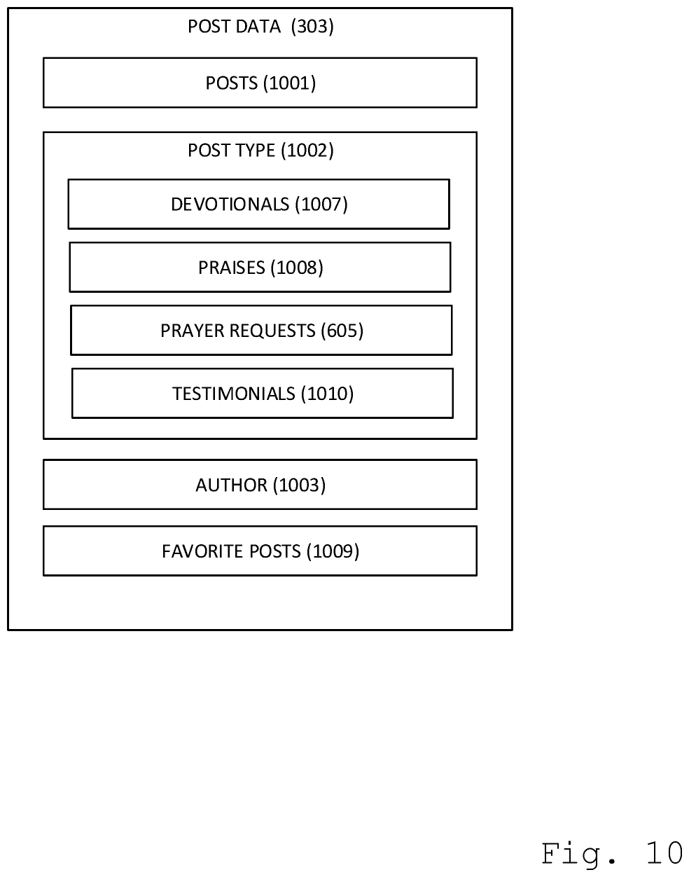

FIG. 10 illustrates an embodiment of post data 303. In one embodiment, post data 303 can comprise a plurality of posts 1001, one or more post types 1002, a plurality of authors 1003, one or more favorite posts 1004. Posts 1001 can be data information or contents, such as a piece of writing, image, prayers, etc. published by each user 301 on social network application 204. In one embodiment, posts 1001 can be related to a feed shown on pages 302 of social network application 204. As an exemplary embodiment, each post 1001 can be created by first user 301a, which once published can comprise feeds on a particular page 302, such as feeds on main page 307, feeds on group page 309, feeds on church page 310, and feeds on life event page 311. Post type 1002 can be a classification of each post 1001. In one embodiment, post type 1002 can comprise a devotional 1007, a praise 1008, a prayer request 605, and a testimonial 1010. Devotional 1007 can be posts 1001 comprising commentary about, or reference to, biblical scripture or related text. As such, created posts 1001 with assigned post type of devotionals can be stored as devotional 1007. Praises 1008 can be posts 1001 comprising words of gratitude addressed to the Lord. As such, created posts 1001 with assigned post type of praises can be stored on praises 1008. Prayer requests 605 can be posts 1001 comprising a personal or group request addressed to the Lord. As such, created posts 1001 with assigned post type of prayer requests can be stored on prayer requests 605. Testimonial 1010 can be posts 1001 comprising a personal experience serving as evidence of biblical truth. As such, created posts 1001 with assigned post type of testimonials can be stored on testimonials 1010. In one embodiment, each post 1001 can be associated to only one post type 1002. As such, each post 1001 can only be published as devotional, praises, prayer request, or testimonial. Author 1003 can be associated to a specific user 301 who published a specific post 1001 on social network application 204. Favorite posts 1004 can comprise posts 1001 marked as favorite by a specific user. In one embodiment, posts 1001 accessible to first user 301a through feeds of a specific page 302 such as main page 307, group page 309, church page 310, and life event page 311 can be marked by first user 301a as favorite. Once marked as favorite, post 1001 marked as favorite can be stored on favorite posts 1004.

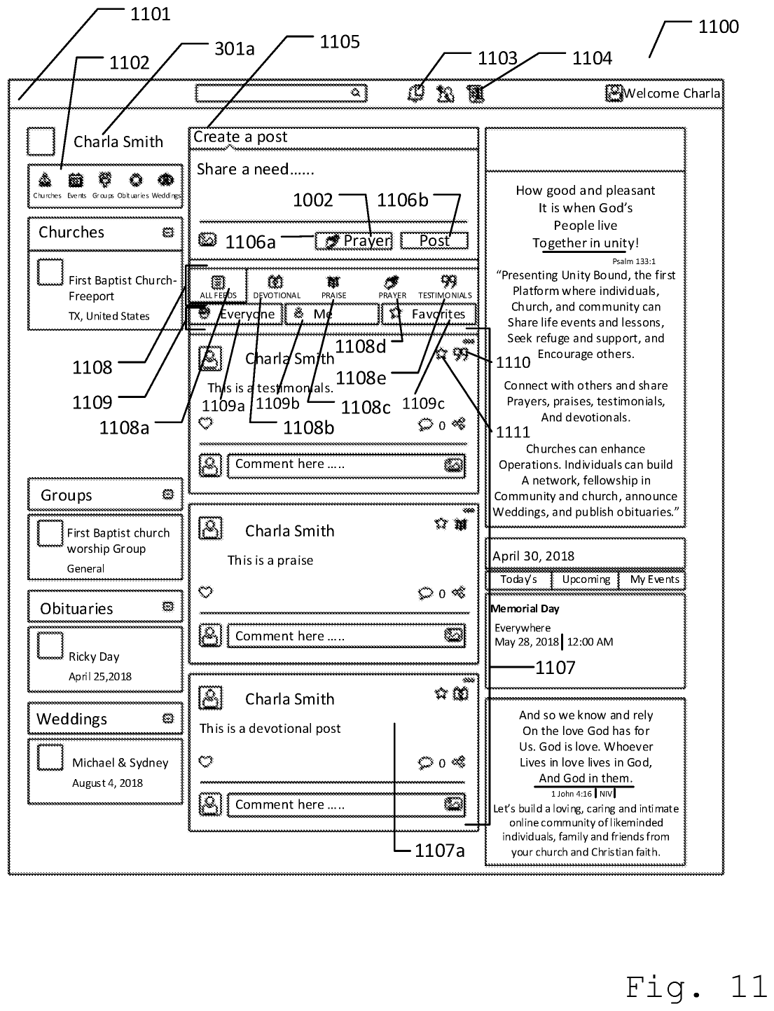

FIG. 11 illustrates main page screen 1100 of social network application 204. Initially, an individual needs to register on social network application 204 to log in and access main page 307 of social network application 204. To register the individual can be required to enter personal information such as name, email address, username, password, date of birth, marital status, access code, and/or gender. In another embodiment, the individual can sign in on social network application 204 through entering the individual's existing social website credentials such as the individual's Facebook account username and password or the individual's Google account username and password. In these embodiments, the individual registering and/or signing in on social network application 204 can relate to creating first user 301a on server data store 205. Once registered, first user 301a can access main page 307 of social network application 204. Further in one embodiment, default login screen for each user 301 can be main page 307. Aside from main page 307, each user 301 can select other page as default login screen, which comprise of profile page 306 or prayer list page 308. Main page screen 1100 can comprise a main toolbar 1101, and a page toolbar 1102. Main toolbar 1101 can comprise graphical control element such as buttons, icons, menus, and other input or output elements, which can allow first user 301a to have constant access to different functions of social network application 204. In one embodiment, main toolbar 1101 can comprise a notification widget 1103, a friend request button, and/or a prayer list page widget 1104. Notification widget 1103 can be used to notify first user 301a about updates on posts of which first user 301a would like to be notified. Prayer list page widget 1104 can allow first user 301a to have a constant access on prayer list page 308. In one embodiment, page toolbar 1102 can allow first user 301a to have constant access to group page 309, church page 310, event page 311, wedding page 312, and obituary page 313. In this embodiment, clicking each specific page 302 from page toolbar 1102 can allow first user 301a to view, search, and join a specific page, group, or event. In another embodiment, clicking on a specific icon on page toolbar 1102 can allow first user 301a to create group page 309, church page 310, event page 311, wedding page 312, and obituary page 313 on social network application 204. Main page 307 can comprise a create-a-post form 1105, a plurality of post feeds 1107, a post type filter 1108, and a scope filter 1109. In one embodiment, create-a-post form 1105 can allow first user 301a to create, publish, and share post 1001 with friends 305. In one embodiment, create-a-post form 1105 can comprise a control widget such as an assign post type widget 1106a, and a post widget 1106b. In one embodiment, assign post type widget 1106a can be a dropdown menu list, comprising post type 1002 as menu list. In such embodiment, clicking assign post type widget 1106a can allow first user 301a to select post type 1002 namely “devotionals”, “praises”, “prayer requests”, and “testimonials”, to be assigned on post 1001 being created. Post widget 1106b can be clicked to publish post 1001 created by user 301. In an example scenario first user 301a who wants to create a prayer request on main page 307 can compose a prayer on create-a-post form 1105. Once prayer is written, first user 301a can select “prayer request” on assign post type widget 1106a, and then click on post widget 1106b to publish prayer request 605 on main page 307.

In one embodiment wherein first user 301a can be logged in, post feeds 1107 on main page screen 1100 can comprise of feed published by first user 301a. In another embodiment, post feeds 1107 can comprise of feed published by first user's co-group member 402. Further in another embodiment, post feeds 1107 can comprise of feed published by first user's co-church member 502. Further each post-feed 1107a can comprise of icons, action buttons, and/or control button. In one embodiment, each post-feed 1107a can comprise an assigned post type 1110, and a favorite mark widget 1111. In one embodiment, assigned post type 1110 can be an icon displayed on each post-feed 1107a indicating specific post type 1002 that was assigned to created post 1001. As such, assigned post type 1110 can be the assigned post-type for each post feed 1107a. As an exemplary embodiment, posts 1001 with assigned post type 1110 of “devotionals” can comprise a “bible” icon on post feeds 1107. Posts 1001 with assigned post type 1110 of “praises” can comprise a “group” icon on post feeds 1107. Posts 1001 with assigned post type 1110 of “prayer requests” can comprise a “praying-hand” icon on post feeds 1107. Posts 1001 with assigned post type 1110 of “testimonials” can comprise a “quotation-mark” icon on post feeds 1107. In one embodiment, favorite mark widget 1111 can be an action button displayed on each post-feed 1107a, which when clicked by first user 301a can mark the specific post-feed 1107a as favorite. In one embodiment, favorite mark widget 1111 can be displayed as an outlined star icon, which when selected can become a shaded star icon to indicate that the specific post-feed 1107a is marked as favorite. In one embodiment, posts 1001 that can be marked as favorite can be stored on favorite posts 1004.

Further, in one embodiment, social network application 204 can display each post feeds 1107 on main page screen 1100 according to a query made by first user 301a. In this embodiment, making a query can be related to selecting specific tabs on main page 307 to filter posts 1001 on main-page post feeds 1107. In other embodiments, a query can be made through clicking a button, or entering specific criteria on a search box to filter posts 1001 displayed on main page 307. As an exemplary embodiment, post-type filter 1108 can comprise an all post- type filter 1108a, a devotional filter 1108b, a praises filter 1108c, a prayer requests filter 1108d, and a testimonials filter 1108e. Post-type filter 1108a can show posts 1001 from all post types 1002, which can include devotionals 1007, praises 1008, prayer requests 605, and testimonials 1010. Devotionals filter 1108b can show posts 1001 with devotionals 407 as assigned post type 1110, while praises filter 1108c can display posts 1001 with praises 408 as assigned post type 1110. Similarly, prayer requests filter 1108d when selected can display posts 1001 whose assigned post type 1110 can be prayer requests 605. And testimonials filter 1108e when selected can display posts 1001 whose assigned post type 1110 matches testimonials 1010. Main-page post feeds 1107 can further be filtered according to scope. In this embodiment, scope filter 1109 can comprise a “show everyone” filter 1109a, a “show only me” filter 1109b, and a “show favorites only” filter 1109c. Show everyone 1109a can display posts 1001 of first user's friends 305, and posts 1001 from co-church members 502, and/or co-group members 402. Show only me 1109b can display posts 1001 whose author 1003 matches first user 301a. Show favorites only 1109c can display posts 1001 that are marked as favorite.

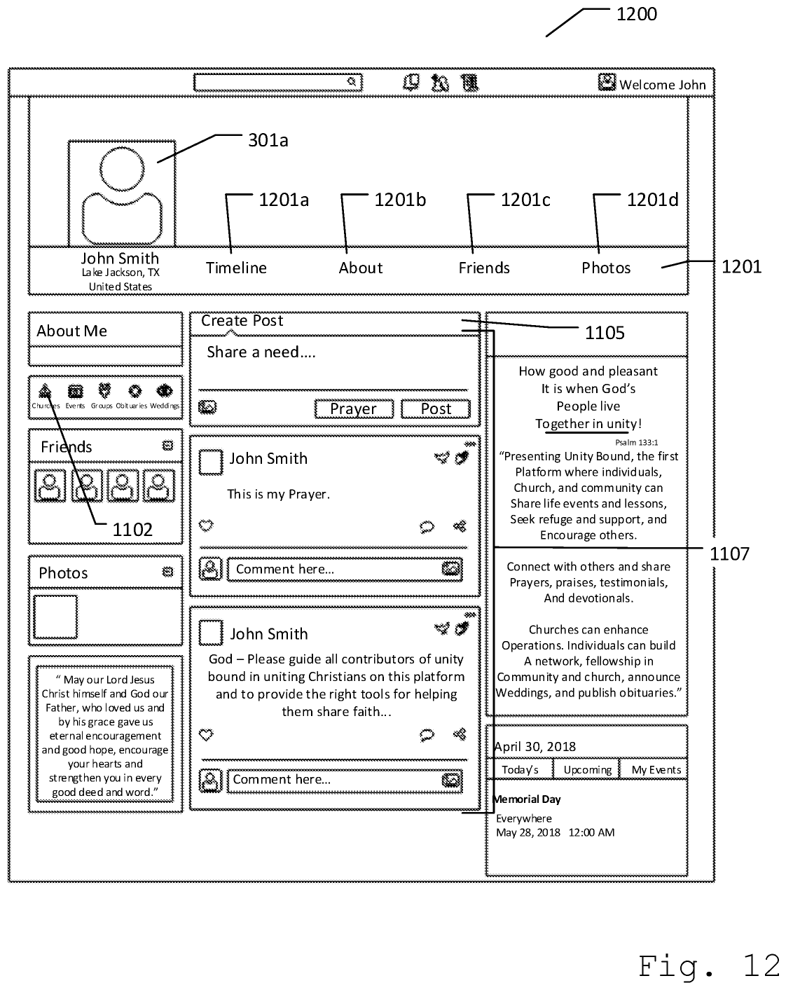

FIG. 12 illustrates a profile page screen 1200. Profile page screen 1200 can comprise information associated with profile page 306. Profile page screen 1200 can comprise create-a- post form 1105, a profile page menu 1201, page toolbar 1102, and post feed 1107. Profile page menu 1201 can be links, buttons, tabs, or control widgets that can allow first user 301a to view, update, delete, and/or add specific information on the owner's profile page 306. As an exemplary embodiment, profile page menu 1201 can comprise information stored on user profile 304, friends 305, pages 302, and post data 303, each related to a specific user 301. As an example, profile page menu 1201 can comprise a plurality of selections including but not limited to a “timeline” selection 1201a, an “about” selection 1201b, a “friends” selection 1201c, a “photos” selection 1201d, and page toolbar 1102. “Timeline” selection 1201a when accessed can display posts 1001 published by first user 301a. “About” selection 1201b when accessed can display a portion of user profile 304, such as address and email address of first user 301a. “Friends” selection 1201c when selected can display friends 305. “Photos” selection 1201d can comprise of photo images that first user 301a added on profile page 306. In another embodiment, profile page menu 1201 can comprise page toolbar 1102 giving first user 301a access to church pages 310, event pages 311, group pages 310, obituary pages 313, and wedding pages 312 from profile page screen 1200. Post feeds 1107 on profile page screen 1200 can comprise posts 1001 created by first user 301a. As such, posts 1001 created on create-a-post form 1105 on profile page screen 1200 can all be authored or associated with first user 301a.

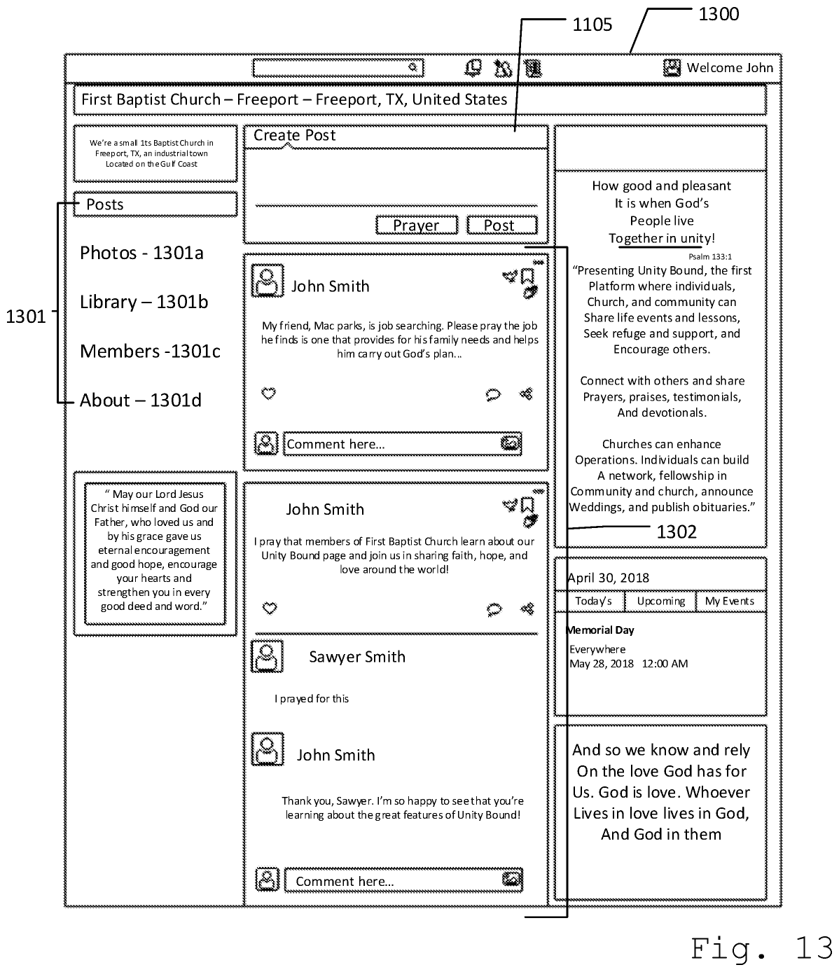

FIG. 13 illustrates an embodiment of an unapproved church page screen 1300. In one embodiment, unapproved church page screen 1300 can comprise information associated to church page 310. In this embodiment, church page screen 1300 can be a newly created church page. In such embodiment, church page screen 1300 can comprise create-a-post-form 1105, a portion of church-page menu 1301, and a church-page post feed 1302. As an example, church-page menu 1301 displayed on unapproved church page screen 1300 can only comprise a plurality of selections including but not limited to a “church photos” selection 1301a, a “church library” selection 1301b, a disabled “church members” selection 1301c, and an “about church” menu 1301d. In one embodiment, church page menu 1301 can be links, buttons, tabs, or control widgets that can allow church page members 502 to view church page information on church page 310. In this embodiment, only first user 301a that created the church page can be allowed to manage church page 310. As such, first user 301a can start building church page 310 while awaiting approval from the site administrator of social network application 204. In unapproved church page screen 1300, the church page creator can be allowed to create post 1001 through create-a-post form 1105 on church page screen 1300. Church page creator can start to publish post 1001 on unapproved church page 1300, manage photos through “church photos” selection 1301a, manage church library 504 through “church library” selection 1301b, and manage church information 501 of church page 310 through “about church” selection 1301d. In one embodiment, church-page post feeds 1302 can be associated to second feed on social network application 204.

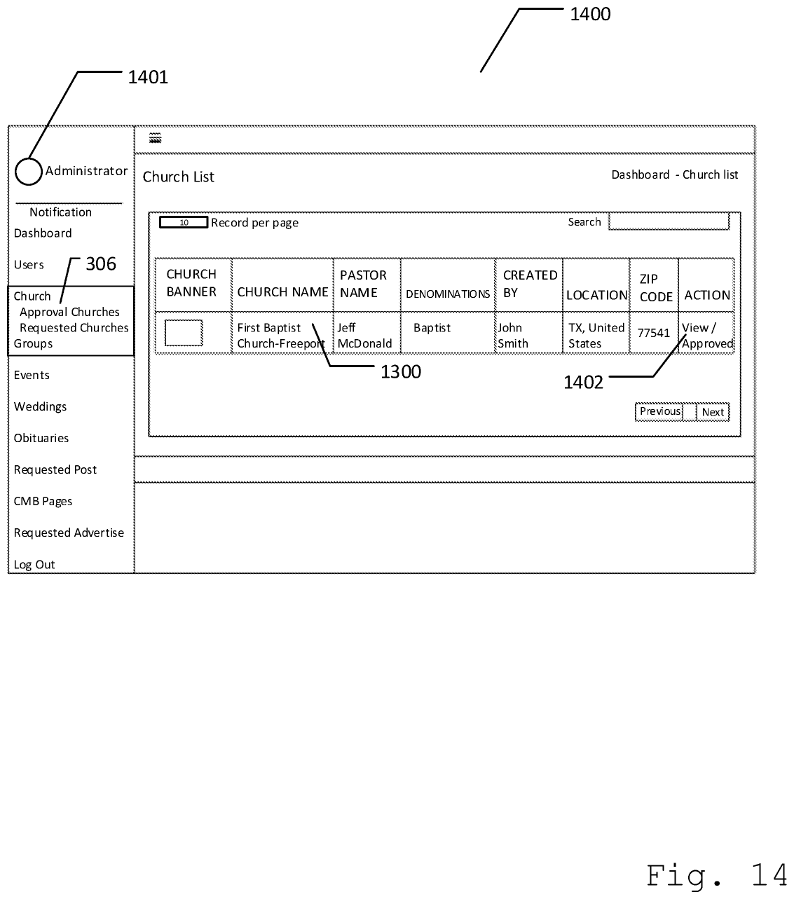

FIG. 14 illustrates a site administrator screen 1400. Site administrator screen 1400 can be a screen only accessible to a site administrator 1401 of social network application 204. In this embodiment, site administrator 1401 can access church pages 310 that can be awaiting approval. In such exemplary embodiment, the site administrator can review church pages, and then approve church pages 306 that meet a church-page creation requirement. As an exemplary embodiment, site administrator 401 can approve unapproved church page 1300 by clicking on an approve church widget 1402 on site administrator screen 1400

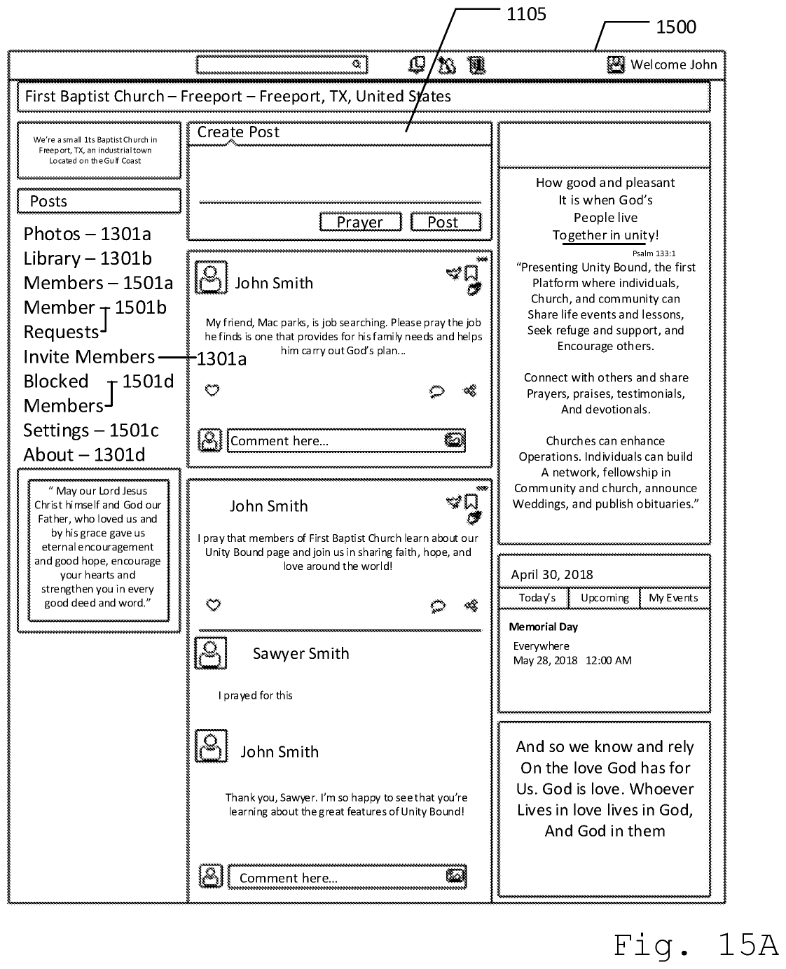

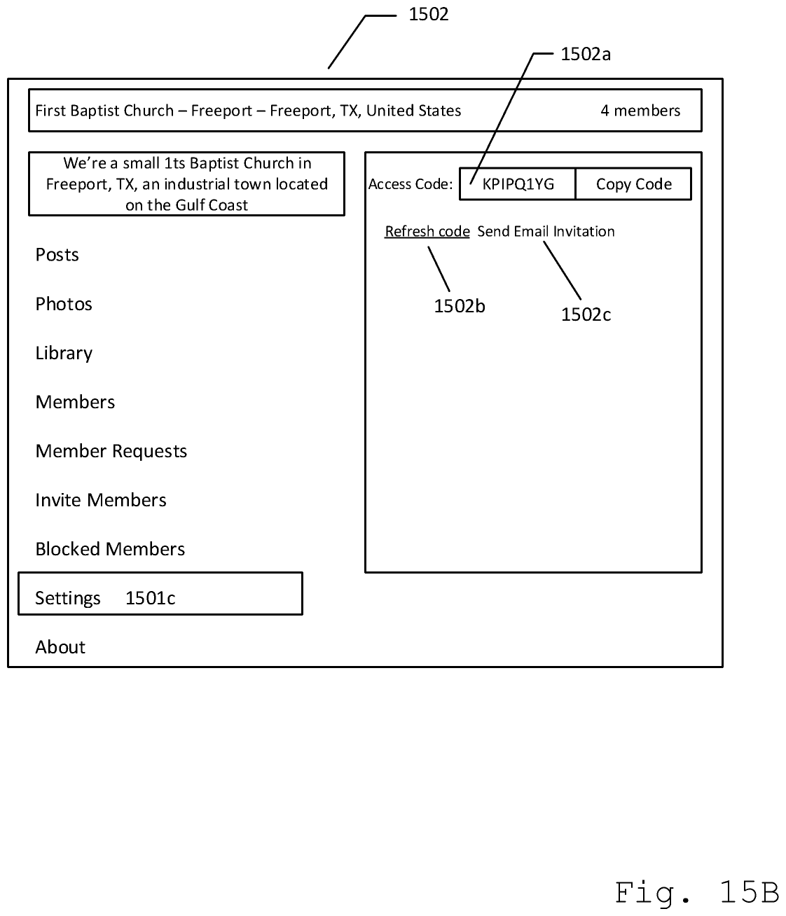

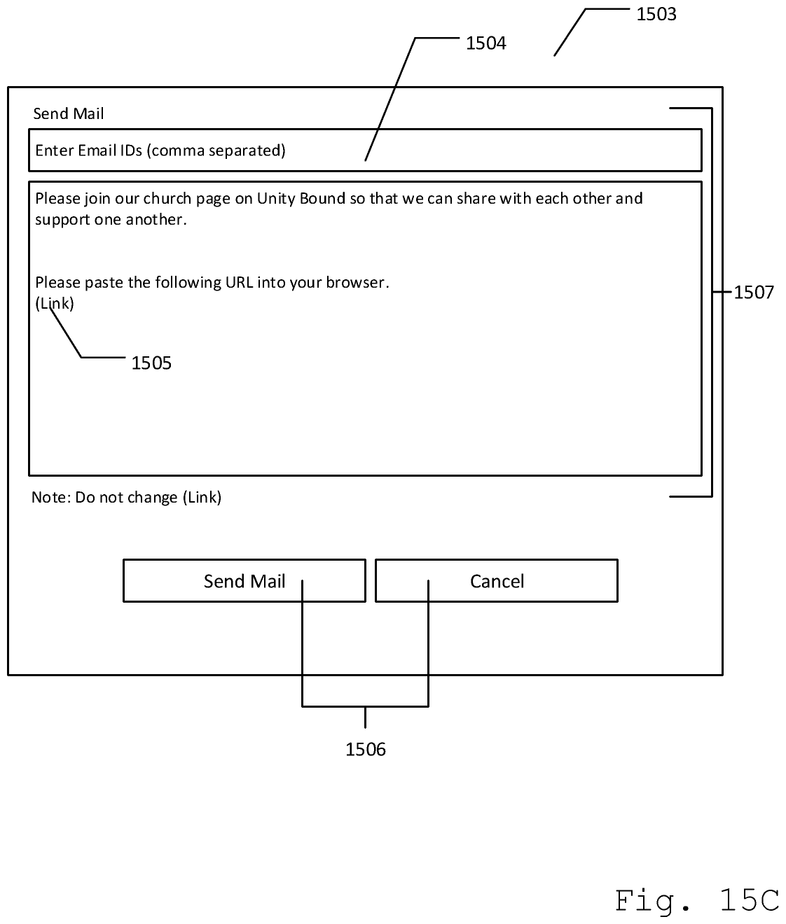

FIG. 15A illustrates an embodiment of an approved church page screen 1500. After the site administrator approved the unapproved church page 1300, a church-page menu 1501 can be displayed on approved church page screen 1500. In one embodiment, approved church page screen 1500 can comprise create-a-post form 1105, “church photos” selection 1301a, “church library” selection 1301b, church-page menu 1501, and an “about church” selection 1301d. As an example, church-page menu 1501 can comprise a plurality of selections that can include but are not limited to an enabled “church members” selection 1501a, a “church member requests” selection 1501b, an “invite church members” selection 1501c, a “blocked church members” selection 1501d, and a “church settings” selection 1501e. Approved church page screen 1500 can allow church members 502 to create and publish posts 1001 within church page 310. Moreover once church page has been approved, “church members” selection 1501a, a “church member requests” selection 1501b, an “invite church members” selection 1501c, a “blocked church members” selection 1501d, and a “church settings” selection 1501e can be enabled and accessible to church administrator 503. As such enabled church member menu 1501 can allow church administrator 503 to view or block members through “church members” selection 1501a, accept or decline members through “church member requests” selection 1501b, invite members through “invite church members” selection 1501c, and/or view or unblock members through “blocked church members” selection 1501d.

In one embodiment wherein approved church page screen 1300 can be set to public, users 301 that can be non-members of church page 310 can still search and view church information 501, and view church members 502 of church page 310. In another embodiment wherein approved church page screen 1300 can be set to private, users 301 that can be non-members of church page 310 cannot view and search for church page 310. In one embodiment, only church administrator 503 can send an invitation, and access “invite church members” selection 1501c on church page 310. As such, “invite church members” selection 1501c can allow church administrator 503 to send an invitation to users 301 that can be within church administrator's friends 305, and church administrator's co-group members 402. In one embodiment, “church settings” selection 1501e can only be accessible to church administrator 503.

Further, create-a-post form 1105 can be accessible to church members 502, and church administrators 503. As such, church members 502, and church administrators 503 can publish posts 1001 on church page screen 1500.

FIG. 15B illustrates settings menu screen 1502. In one embodiment, selecting “church settings” selection 1501e can display settings menu screen 1502. Settings menu screen 1502 can comprise an access code widget 1502a, a refresh code widget 1502b, and a send email invitation widget 1502c. Access code widget 1502a can allow church administrator 503 to view access code 505 assigned to church page 310. In one embodiment, church administrators 503 can renew access code 505 manually. As such, church administrator 503 can renew access code 505 by clicking refresh code widget 1502b to regenerate a new access code at any time. In another embodiment, access code 505 can be automatically regenerated by social network application 204 at a specified time interval. Further in some embodiments, access code 505 can be sent to individuals through an email. As such, church administrator 503 can click on send email invitation widget 1502c to invite other users 301 who are non-members of church page 310.

FIG. 15C illustrates email invitation screen 1503. Clicking send email invitation widget 1502c can display email invitation screen 1503. In this embodiment, email invitation screen 1503 can comprise an email address box 1504, access code link 1505, and invitation action buttons 1506. Email address box 1504 can allow church administrator 503 to send a church invitation email 1507 to other individuals by filling up email address box 1504 with other individuals email addresses. Once sent, invited individuals can receive church invitation email 1507 on their email. In an embodiment wherein invited individuals can be a registered user of social network application 204, clicking a hyperlink which can be access code link 1505 from church invitation 1507 can redirect the individuals to login on social network application 204.

After logging in, access code link 1505 can direct the individuals to church page 310. Once redirected to church page 310, access code widget 1502a on church page 310 can be prepopulated with a value, so that when the individual decides to joins church page 310, the individual's member request can be automatically accepted. In another embodiment wherein invited individuals are not yet a registered user of social network application 204, clicking access code link 1505 from church invitation email 1507 can redirect the individuals to a registration page of social network application 204. The registration page can have a prepopulated access code 505 such that when the individuals submit the registration information the member request of the newly registered individuals can be automatically accepted.

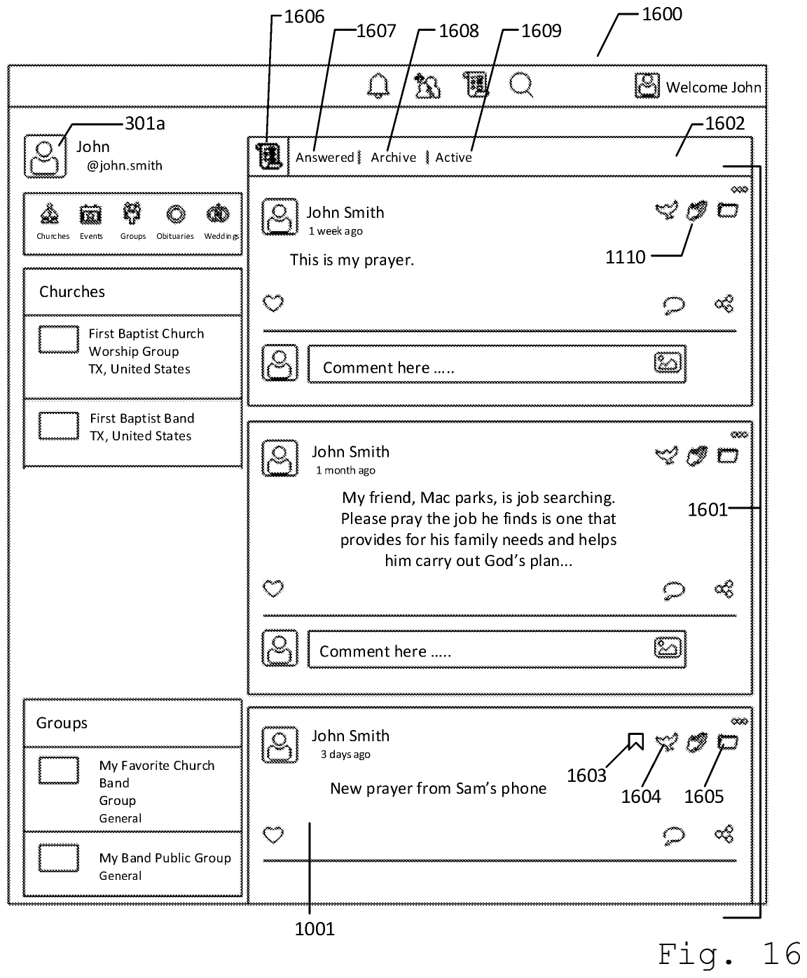

FIG. 16 illustrates a prayer list screen 1600. Prayer list screen 1600 can comprise information associated to prayer list page 308. Prayer list screen 1600 can comprise of a prayer requests feed 1601 and a prayer list filter 1602. Prayer requests feeds 1601 can be associated with posts 1001 on post feeds 1107 with assigned post type 1110 of prayer requests 605. Prayer requests feed 1601 can comprise of icons, action buttons, and/or control button. In one embodiment, each prayer requests feed 1601a on prayer list screen 1600 can comprise assigned post type 1110, a bookmark widget 1603, an answered prayer widget 1604 and an archive widget 1605. In one embodiment, bookmark widget 1603 can be displayed with an outlined flag icon. When clicked, outlined flag icon can be shaded to indicate that prayer requests feed 1601 has been bookmarked. In one embodiment, bookmark widget 1603 can only be displayed on prayer requests feed 1601 made by users other than the page owner—first user 301a. In one embodiment, post feeds 1107 with assigned post type 1110 of prayer requests 605 created by first user's friends 305 can comprise bookmark widget 1603. In such embodiment, first user 301 can bookmark prayer requests 605 that can belong to a friend of friends 305. In another embodiment, post feeds 1107 with assigned post type 1110 of prayer request 605 that can be created by first user's co-group member 402 can comprise bookmark widget 1603. In such embodiment, first user 301 can book mark prayer requests 605 that can belong to co-group member 402. Further in another embodiment, post feeds 1107 with assigned post type 1110 of prayer request 605 that can be created by co-church member 502 can comprise bookmark widget 1603. In such embodiment, first user 301 can bookmark prayer requests 605 that belong to a co- church member.

Further in one embodiment, bookmarking prayer requests feed 1601 can be related to storing the bookmarked prayer requests 605 under prayer request list 601. In one embodiment, answered prayer widget 1604 can be displayed as a bird icon. When answered prayer widget 1604 is clicked, bird icon can be highlighted to indicate that the specific prayer request feed 1601a has been answered. In one embodiment, marking or clicking answered prayer widget 1604 on the specific prayer request feed 1601 can be related to storing the specific answered prayer request 605 under answered prayers 602. Further in one embodiment, notification widget 1103 can be triggered every time each prayer request feed 1601 can be marked as answered. Archive widget 1605 can be displayed on each prayer request feeds 1602a with a folder icon. When clicked, folder icon can be highlighted to indicate that prayer request 605 has been archived. Clicking archive widget 1605 on a specific prayer request 605c an be related to moving the specific prayer request 605 under archived prayers 603.

Prayer list filter 1602 can be links, buttons, tabs, or control widgets that can allow first user 301a to view and manage prayer requests 605 displayed on prayer list screen 1600. In an example embodiment, prayer list filter 1602 can comprise a prayer-request filter 1606, an answered prayers filter 1607, an archived prayers filter 1608, and an active prayers filter 1609. Selecting prayer-request filter 1606 can display prayer requests 605 created by first user 301a and can display prayer request 605 that has been bookmarked by first user 301a. Selecting answered prayers filter 1607 can display prayer requests 605 stored under answered prayers 602. Selecting archived prayers filter 1608 can display prayer requests 605 stored under archived prayers 603. Selecting active prayers filter 1609 can display prayer requests 605 stored under active prayers 604.

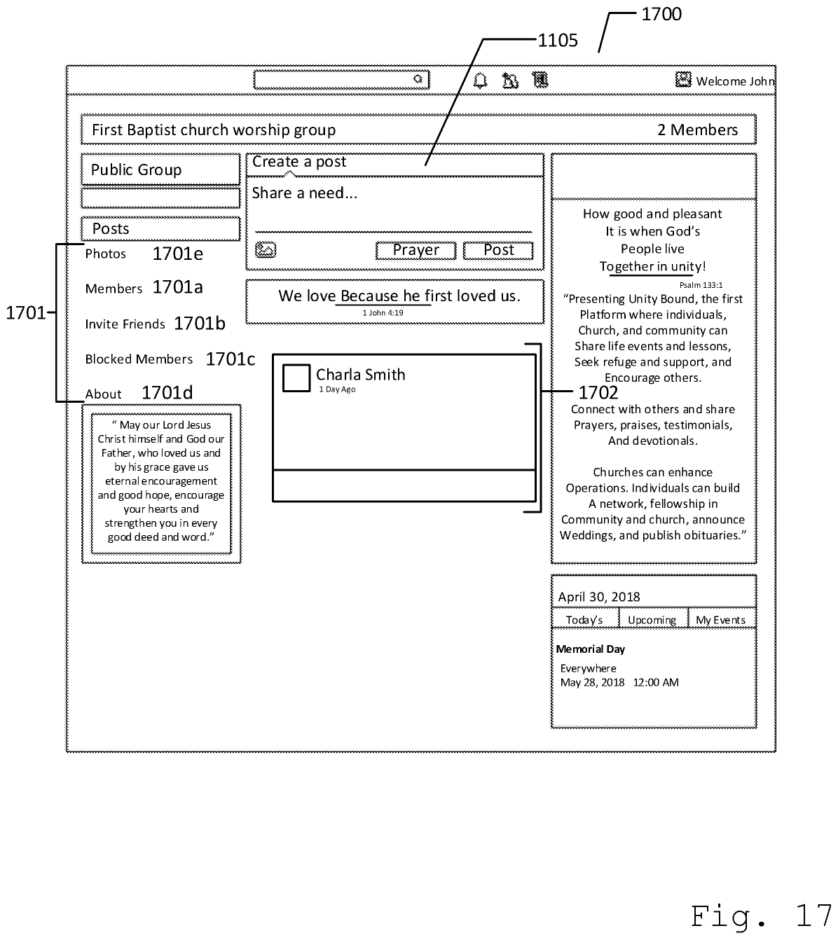

FIG. 17 illustrates a public group page screen 1700. In one embodiment, group page screen 1700 can comprise information associated with group page 309. Group page screen 1700 can comprise create-a-post form 1105, a group page menu 1701, and a group-page post feed 1702. Group page menu 1701 can be links, buttons, tabs, or control widgets that can allow group members 402 and group administrator 403 to access contents of group page 309. As an example embodiment, group page menu 1701 can comprise a plurality of selections that can include but not limited to a “group members” selection 1701a, an “invite friends” 1701b, a “blocked group members” selection 1701c, an “about group” selection 1701d, and a “group members photos” selection 1701e. Group members 402 and group administrators 403 can be allowed to create and publish posts 1001 on group page screen 1700 through create-a-post form 1105.

Group members 402, and group administrators 403 can be allowed to share image files through “group members photos” selection 1701e, view other group members 402 through “group member” selection 1701a, and view group profile 401 through “about group” selection 1701d. Group administrator 403 can have the permission to remove, or block members from viewing group page 309. As such, group administrator 403 can access “group members” selection 1701a to remove or block group members 402 from group page 309. In one embodiment, group members 402 and group administrators 403 can invite other users 301 to join group page 309 by accessing “invite friends” 1701b. In such embodiment, each group member 402 including group administrators 403 can invite other users 301 that can be non-members to the group. As an example embodiment wherein first user 301a can be group administrator 403, “invite friends” 1701b can allow group administrator 403 to select users 301 that can be within first user's friends 305. In such example embodiment, “invite friends” 1701b can also allow group administrator 403 to select users 301 that can be within first user's co-group members 402. Moreover in such example embodiment, “invite friends” 170 lb can allow group administrator 403 to select users 301 that can be within first user's co-church members 502.

In an embodiment wherein group page 309 can be public group page, non-members of group page 309 can still be permitted to view group members 402 through accessing “group members” selection 1701a. Non-members can also view group profile 401 through accessing “about group” selection 1701d, but non-members cannot be permitted to access “invite friends” selection 1701b, and “blocked group members” selection 1701c.

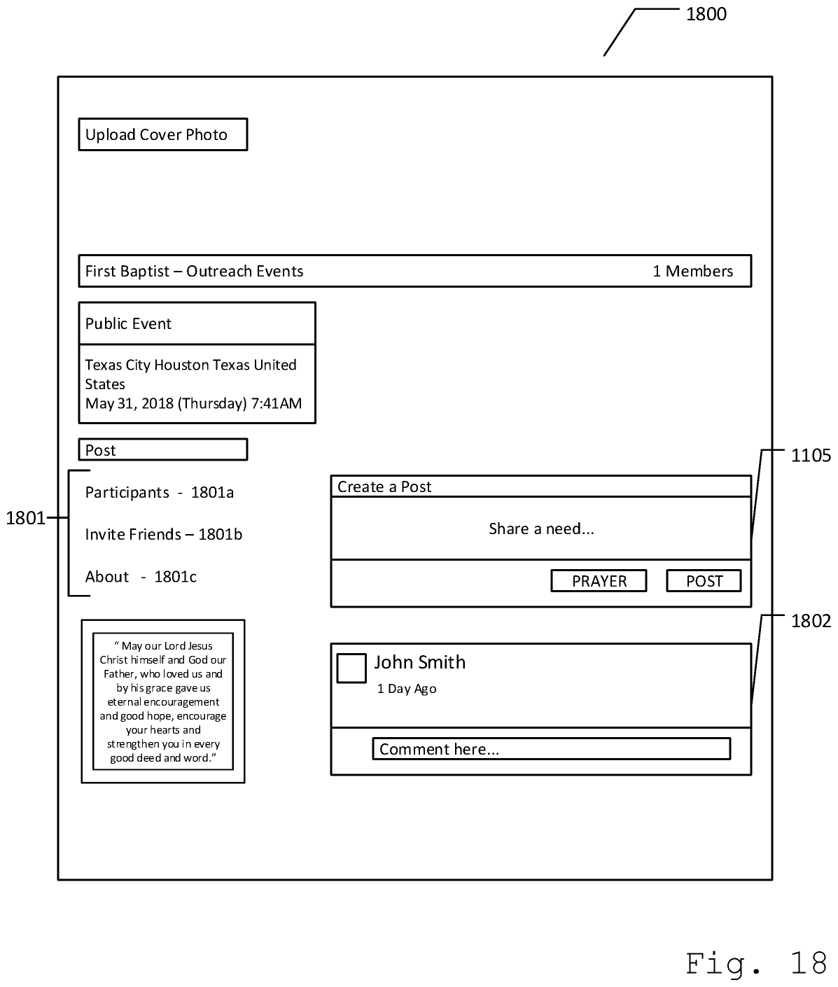

FIG. 18 illustrates a public event embodiment of life event screen 1800. In one embodiment life event screen 1800 can comprise information associated to life event page 311. Life event screen 1800 can comprise create-a-post form 1105, an event page menu 1801, and an event post feed 1802. Event page menu 1801 can be links, buttons, tabs, or control widgets that can allow event participants 705 and event administrator 703 to access contents of life event page 311. As an example embodiment, event page menu 1801 can comprise a plurality of selections which can include but not limited to a “participants” selection 1801a, an administrator “invite friends” selection 1801b, and an about event menu 1801c. Event administrators 703 and event participants 705 can be allowed to create and publish posts 1001 on life event screen 1800 through create-a-post form 1105, which can be posted as event post feed 1802. Moreover, event administrators 703 and event participants 705 can view event participants 705 through accessing participants menu 1801a, view about event information 701 by accessing about event menu 1801c. In one embodiment, only event administrator 703 can have the permission to invite participants of an event. In such embodiment, event administrator 703 can invite other participants to join the event by inviting friends 305 through administrator “invite friend” selection 1801b. In another embodiment, event administrator 703 can invite co-group members 402 to participate in the event. In one embodiment, after choosing to invite participants, administrator 703 can merely pick a particular group in which administrator is involved, and all members of such group will have access to life event page 311. In another embodiment, administrator 703 can have the option of picking individual group members from groups in which administrator 703 belongs. Further in another embodiment, event administrator 703 can invite co-church members 502 to participate on the event. In one embodiment, after choosing to invite participants, administrator 703 can merely pick a particular church group in which administrator is involved, and all members of such church will have access to life event page 311. In another embodiment, administrator 703 can have the option of picking individual church members from a church in which administrator 703 belongs.

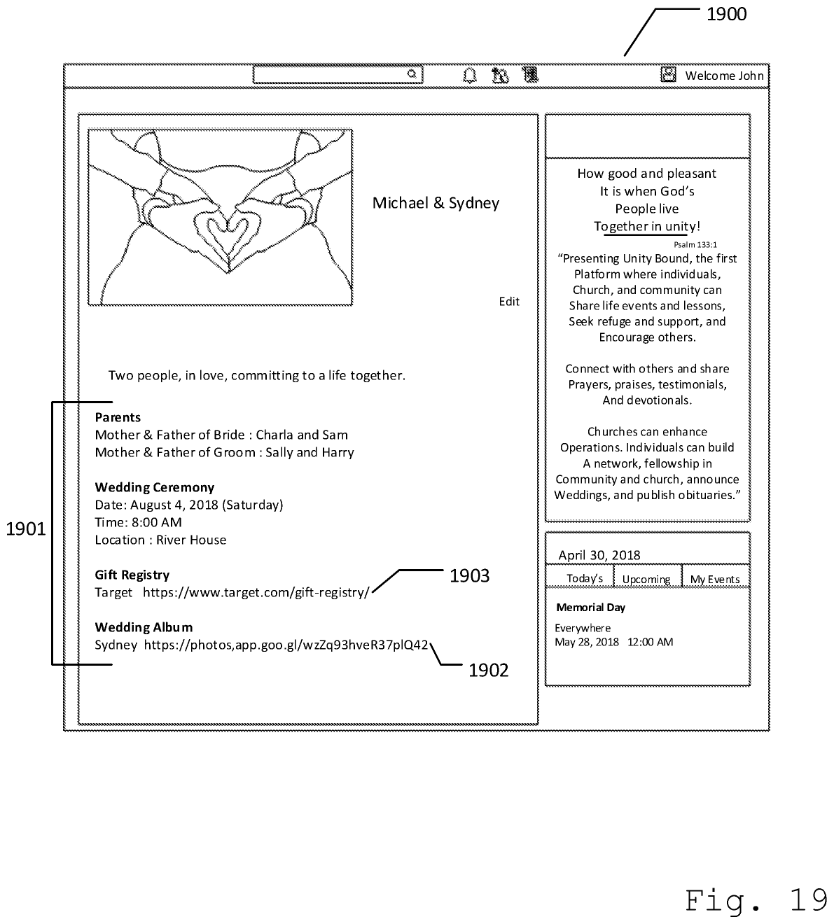

FIG. 19 illustrates a wedding page screen 1900. In one embodiment wedding page screen 1900 can comprise information associated to wedding page 312. Wedding page screen 1900 can comprise wedding details 1901, a wedding photo 1902, a gift registry link 1903. Wedding details 1901 can display contents stored within wedding information 801, such as name of bride and groom, name of the parents of bride and groom, and wedding ceremony details. Wedding photo 1902 can be a link or an icon that can comprise wedding photos, or other photos related to the wedding ceremony. Gift registry link 1903 can be a wedding registry link accessible to invited guests 803. In one embodiment, wedding page screen 1900 can be related to private event 707. In such embodiment, only specific users 301, such as invited guest 803 can be allowed to view wedding page 312. In one embodiment, users 301 that are invited guests 803 can RSVP through wedding page screen 1900. As such, invited guest 803 can choose to accept the invitation, or decline the invitation. Once invited guest 803 accepts the wedding invitation, invited guest 803 can be added on wedding participants 804.

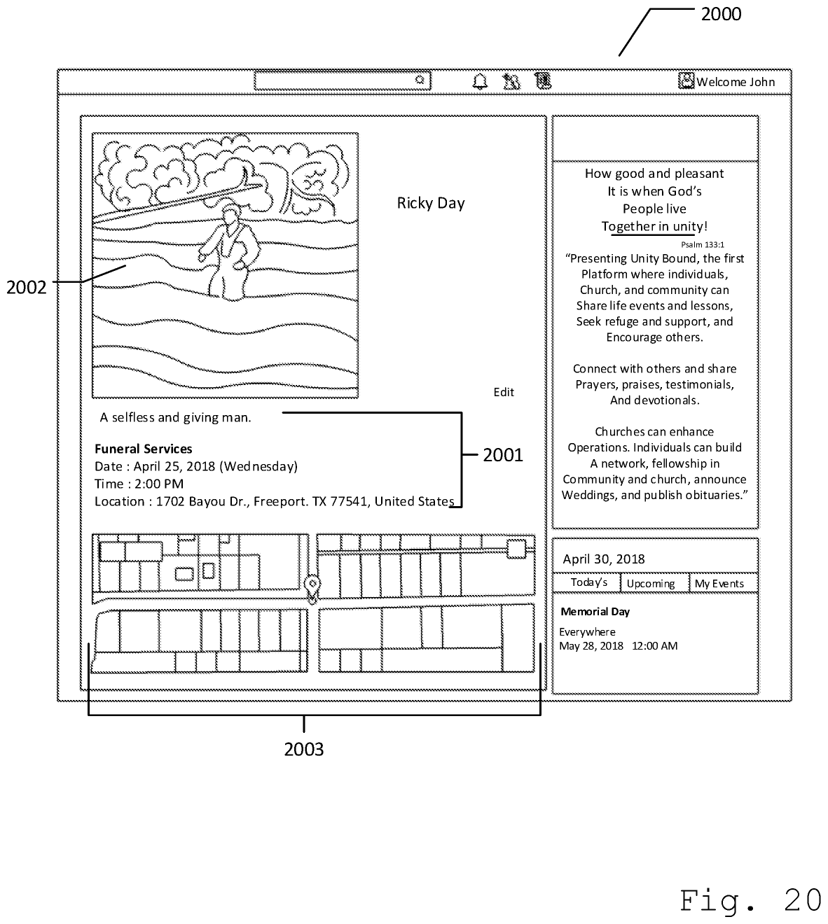

FIG. 20 illustrates an obituary screen 2000. In one embodiment obituary page screen 2000 can comprise information associated to obituary page 313. Obituary screen 1200 can comprise obituary details 2001, one or more obituary photos 2002, a funeral service map 2003. Obituary details 2001 can display contents stored within obituary information 901, such as name of the decedent, obituary text, and funeral service details. Obituary photo 2002 can be a link or an image of the decedent. In one embodiment, obituary screen 2000 can be related to private event 707. In such embodiment, only specific users 301, such as obituary invitees 903 can be allowed to view obituary page 313.

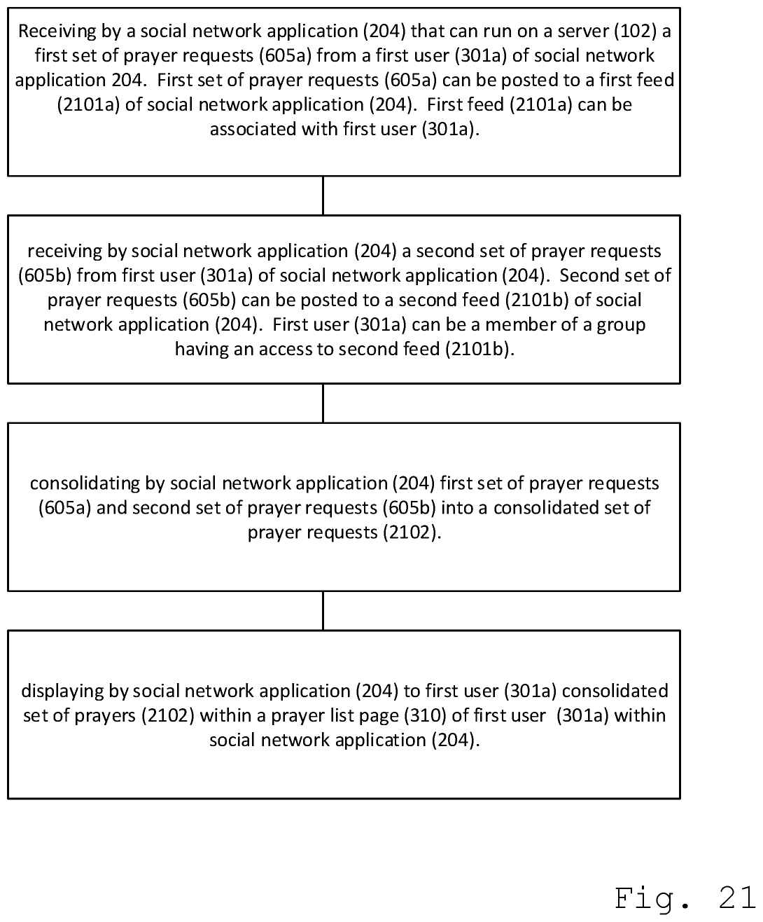

FIG. 21 illustrates an exemplary method for managing prayer requests 605 within a social networking environment. Initially, first user 301a can login on social network application 204 to manage prayer requests 605. Once logged in, first user 301a can create a first set of prayer request 605a on social network application 204. First user 301a can create first set of prayer request 605a through a first feed 2101a of social network application 204. In one embodiment, first feed 2101a can be feeds displayed on main page screen 1100. In such embodiment, first feed 2101a can be post feed 1107. In another embodiment, first feed 2101a can be displayed on personal page screen 1200. In such embodiment, first user 301a can create first set of prayer request 605a on personal page screen 1200. As such, first user 301a can use create-a-post form 1105 to compose prayer request. First user 301a can also select “prayer request” on assign a post type widget 1106a, and click post widget 1106b to publish first set of prayer request 605a. Once created, social network application 204 can receive first set of prayer request 605a and store it within data store 205.

Further, first user 301a can create a second set of prayer request 605b on a second feed 2101b. Once created, social network application 204 can receive second set of prayer request 605a and store it within data store 205. In one embodiment, second feed 2101b can be displayed on a group page 309 that first user 301a belongs to. In this embodiment, first user 301a can publish second set of prayer request 605a on group page 309. In such embodiment, second feed 2101b can be group post feed 1702. In another embodiment, second feed 2101b can be a church page 310 that first user 301a belongs to. In this embodiment, first user 301a can publish second set of prayer request 605a on church page screen 1500. In such embodiment, second feed 2101b can be church post feed 1302. Further, in another embodiment, second feed 2101b can be a life event page 311 that first user 301a created. In such embodiment, first user 301a can publish second set of prayer request 605a on life event page screen 1800. In such embodiment, second feed 2101b can be event post feed 1802.

Social network application 204 can then consolidate first set of prayer requests 605a and second set of prayer requests 605b created by user 301a on a consolidated set of prayer requests 2102. In one embodiment, consolidated set of prayer requests 2005 can be prayer request list 601. Consolidated set of prayer requests 2102 can then be displayed to first user 301a through accessing prayer list screen 1700. In one embodiment, consolidated set of prayer requests 2102 can be consolidated within prayer list page 310.

Further in one embodiment, when prayer request 605 on consolidated set of prayer request 2102 has been marked as answered, social network application 204 can receive a notification from first user 301a. As such, social network application 204 can remove prayer request 605 from consolidated set of prayer request 2102 and then move prayer request 605 into archived prayers 604.

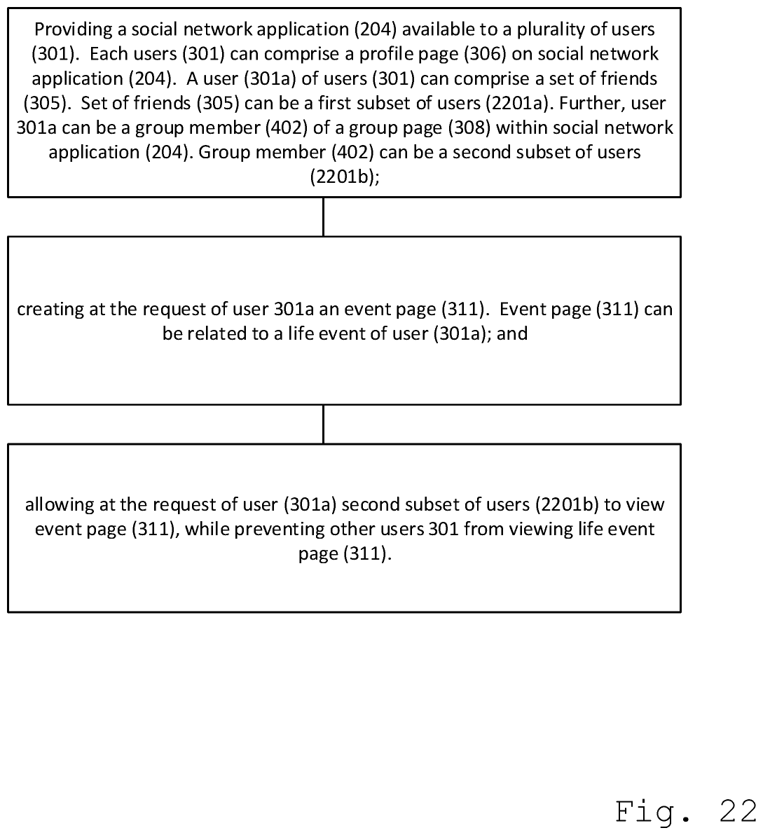

FIG. 22 illustrates an exemplary method for facilitating life event page 1800 within a social network application 204. First user 301a can first log in on social network application 204 to access life event page 1800. Once logged in, social networking application 204 can provide user 301a access to profile page 306. As such, first user 301a can start connecting with subset of users 2201 through social network application 204. In one embodiment, first user 301a can connect with first subset of users 2201a by adding set of friends 305. In another embodiment, first user 301a, who can be a member of group page 309, can connect with second subset of users 2201a by adding co-group members 402. In another embodiment, first user 301a that can be a member of church page 310 can connect with second subset of users 2201a by adding co-church members 402.

In one embodiment, after first user 301a creates the connection with set of friends 305, co-group members 402, and co-church members 502. Initially, first user 301a can create event page 311 by logging into social network application 204 and then creating an event page 311. Once event page 311 has been created, first user 301a can allow subset of users 2201 view and access event page 311. In one embodiment wherein event page 311 can be a private event, social network application 204 can prevent non-members of event page 311 view of specific contents on event page 311. In another embodiment, first user 301 can send invitations to subset of users 2201 to select who can be permitted to view event page 311.

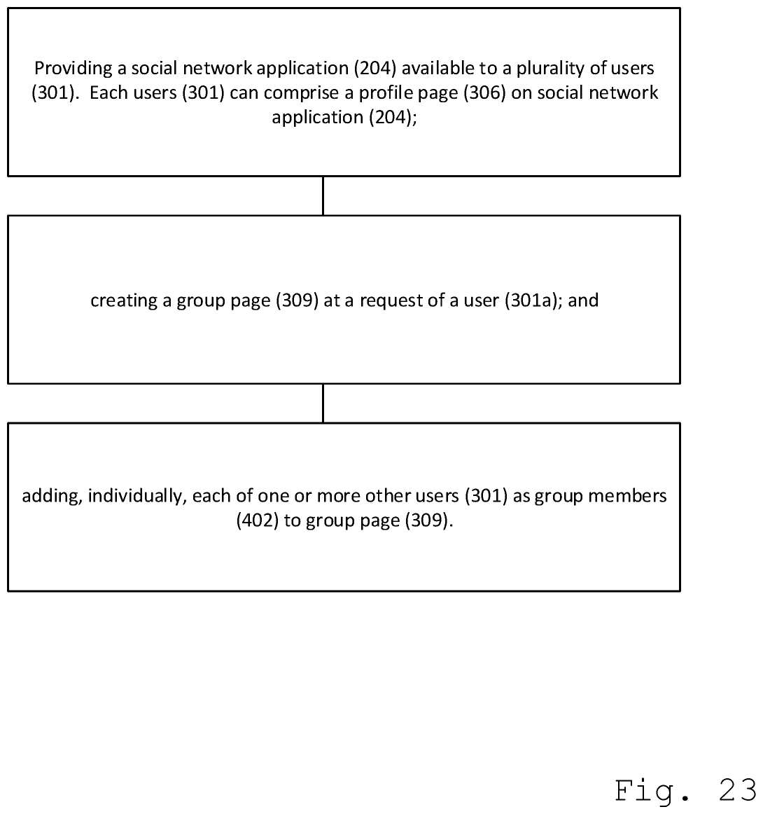

FIG. 23 illustrates an exemplary method for facilitating church member networking within a social network application 204. First user 301a can be registered on social network application 204 can create a specific page 302 on social network application 204. In one embodiment, first user 301a can create church page 310 on social network application 204. Once created, first user 301a can start inviting individuals into church page 310. In one embodiment, first user 301a can give out access code 505 to other users 301. In one embodiment, access code 505 can be sent by first user 301a through an email. In such embodiment, invited user can access their email and click access code link 1505 to be directed to church page 310. In this embodiment, social network application 204 can auto fill access code 505 on church page 310 such that when invited user chooses to join church page 310, invited users member request can be automatically accepted. In another embodiment, access code 505 can be given manually or verbally to invited individuals. Further in another embodiment, first user 301a can manually select each user 301 by accessing “invite church members” selection 1301a, and sending an invite to each user 301.

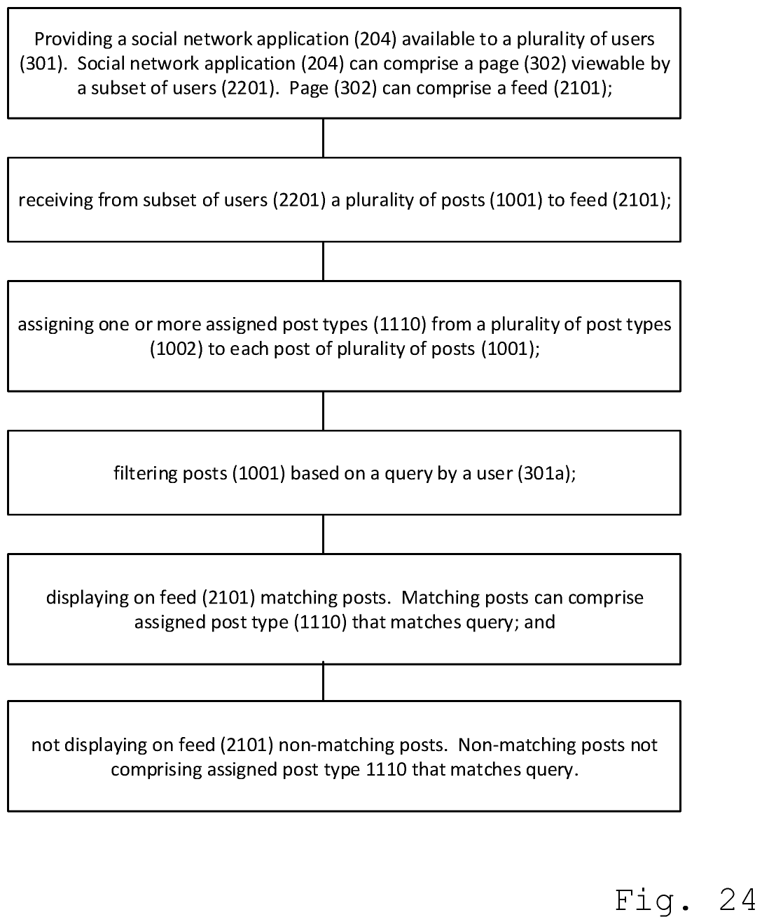

FIG. 24 illustrates an exemplary method for filtering feeds within social network application 204. First user 301a that can be currently logged in on social network application 204 can be allowed to view post feeds 1107 on main page screen 1110. Main page screen 1110 can comprise post type filter 1108 and scope filter 1109 that can query posts 1001 on post feeds 1107. In one embodiment, each post feeds 1107 created by each user 301 can be associated with post types 1002. As such, social networking application 204 can query first user's main page screen 1110 according to post type through post type filter 1108.

Further in one embodiment, post feeds 1107 can comprise posts 1001 that can be created by first user 301. In another embodiment, post feeds 1107 can comprise posts 1001 that can be created by first user's friends 305. Further in one embodiment, post feeds 1107 can comprise of posts 1001 that can be created by first user's co-group members 402. In another embodiment, post feeds 1107 can comprise of posts 1001 that can be created by first user's co-church members 402. Further in another embodiment, each post feeds 1107 can comprise a favorite post widget 1111. As such, social network application 204 can allow first user 301a to filter post feeds 1107 on main page 307 according to scope type using scope filter 1109.

As an example scenario, first user 301a can query post feeds 1107 by selecting a specific post type filter 1108, and a specific scope filter 1109. Posts 1001 that can match the criteria on selected post type filter 1108 and selected scope filter 1109 can display a matching post on post feeds 1107, while a non-matching post cannot be displayed on post feeds 1107. Non-matching posts can be posts 1001 that does not match the criteria of the selected post type filter 1108 and the selected scope filter 1109. Using FIG. 10 as an example scenario, wherein first user 301a named “Charla Smith” that wants to view all posts made by herself, can select filters all post-type filter 1108a and show only me 1109b to display on post feeds 1107 all types of post made by first user 301a.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A method for filtering feeds within a social network application comprising providing a social network application available to a plurality of users, said social network application further comprising a page viewable by a subset of said plurality of users, said page comprising a feed;
receiving from said subset of users a plurality of posts to said feed;
assigning one or more assigned post types from a plurality of post types to each post of said plurality of posts;
filtering said posts based on a query by a user;
displaying on said feed matching posts, said matching posts comprising said assigned post type that matches said query; and
not displaying on said feed said non-matching posts, said non-matching posts not comprising said assigned post type that matches said query.

2. The method of claim 1 wherein said assignment of said one or more post types to each said posts is at creation of each said post.

3. The method of claim 1 wherein said assignment of said one or more post types to each said posts is after creation of each said post.

4. The method of claim 1 wherein said plurality of post types comprises a prayer post.

5. The method of claim 1 wherein said plurality of post types comprises a devotional post.

6. The method of claim 1 wherein said plurality of post types comprises a testimonial post.

7. The method of claim 1 wherein said plurality of post types comprises a praise post.

8. The method of claim 1 further comprising the step of further filtering said matching posts such that only said posts posted by said user are displayed on said feed.

9. The method of claim 1 further comprising the step of further filtering said matching posts such that only said posts posted not by said user are displayed on said feed.

10. The method of claim 1 further comprising the step of further filtering said matching posts such that only said posts favorited by said user are displayed on said feed.

11. The method of claim 1 wherein said page is a profile page.

12. The method of claim 1 wherein said page is a group page.

13. The method of claim 1 wherein said page is a life event page.

14. A system for filtering feeds within a social network application comprising
a memory comprising a social network application and a data store; and
a processor that, at the instruction of social networking application,
connects a plurality of users, said social network application further comprising a page viewable by a subset of said plurality of users, said page comprising a feed;
receives from said subset of users a plurality of posts to said feed;
assigns one or more assigned post types from a plurality of post types to each post of said plurality of posts;
filters said posts based on a query by a user;
displays on said feed matching posts, said matching posts comprising said assigned post type that matches said query; and
does not display on said feed said non-matching posts, said non-matching posts not comprising said assigned post type that matches said query.

15. The system of claim 14 wherein said assignment of said one or more post types to each said posts is at creation of each said post.

16. The system of claim 14 wherein said assignment of said one or more post types to each said posts is after creation of each said post.

17. The system of claim 14 wherein said processor further filters said matching posts such that only said posts posted by said user are displayed on said feed.

18. The system of claim 14 wherein said processor further filters said matching posts such that only said posts posted not by said user are displayed on said feed.

19. The system of claim 14 wherein said processor further filters said matching posts such that only said posts favorited by said user are displayed on said feed.

20. A computer readable storage medium having a computer readable program code embodied therein, wherein the computer readable program code is adapted to be executed to implement the method of claim 1.
